(19) United States
(12) Patent Application Publication
(10) Pub. No.: US 2009/0048395 A1
(43) Pub. Date: Feb. 19, 2009

(54) OLIGOMERIC AND POLYMERIC SILOXANES SUBSTITUTED BY ARYLPHOSPHONIC ACIDS

(75) Inventors: Helmut Mohwald, Annweiler (DE); Thorsten Bock, Freiburg (DE); Rolf Mulhaupt, Freiburg (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/279,656

(22) PCT Filed: Feb. 13, 2007
(86) PCT No.: PCT/EP2007/051381

§ 371 Date: Aug. 15, 2008

(30) Foreign Application Priority Data
Feb. 17, 2006 (EP) 06110126.7

(51) Int. Cl. C08G 77/30; C08L 83/06

(52) U.S. Cl. 524/588; 525/474; 525/477

(57) ABSTRACT

The present invention relates to oligomeric or polymeric siloxanes comprising phosphonic acid groups, a process for preparing them, oligomeric or polymeric siloxanes comprising silyl phosphonate and/or alkyl phosphonate groups, blends comprising at least one oligomeric or polymeric siloxane according to the invention comprising polyphosphonic acid groups and/or at least one oligomeric or polymeric siloxane comprising silyl phosphonate and/or alkyl phosphonate groups and at least one further polymer, membranes, films or composites comprising at least one oligomeric or polymeric siloxane according to the invention comprising phosphonic acid groups and/or at least one oligomeric or polymeric siloxane according to the invention comprising silyl polyphosphonate and/or alkyl polyphosphonate groups or a blend according to the invention, and also various uses of oligomeric or polymeric siloxanes comprising phosphonic acid groups and/or oligomeric or polymeric siloxanes comprising silyl phosphonate and/or alkyl phosphonate groups or blends according to the invention.

The present invention relates to oligomeric or polymeric siloxanes comprising phosphonic acid groups, a process for preparing them, oligomeric or polymeric siloxanes comprising silyl phosphonate and/or alkyl phosphonate groups, blends comprising at least one oligomeric or polymeric siloxane according to the invention comprising polyphosphonic acid groups and/or at least one oligomeric or polymeric siloxane comprising silyl phosphonate and/or alkyl phosphonate groups and at least one further polymer, membranes, films or composites comprising at least one oligomeric or polymeric siloxane according to the invention comprising phosphonic acid groups and/or at least one oligomeric or polymeric siloxane according to the invention comprising silyl polyphosphonate and/or alkyl polyphosphonate groups or a blend according to the invention, the use of oligomeric or polymeric siloxanes comprising phosphonic acid groups and/or an oligomeric or polymeric siloxane comprising silyl phosphonate and/or alkyl phosphonate groups or a blend according to the invention in membranes, films or composites, the use of the membranes of the invention in fuel cells or as membranes in separation technology, a fuel cell comprising at least one membrane according to the invention or at least one oligomeric or polymeric siloxane comprising phosphonic acid groups and/or at least one oligomeric or polymeric siloxane comprising silyl phosphonate and/or alkyl phosphonate groups or a blend according to the invention, the use of the oligomeric or polymeric siloxanes of the invention comprising phosphonic acid groups and/or oligomeric or polymeric siloxanes comprising silyl phosphonate and/or alkyl phosphonate groups or a blend according to the invention for reducing swelling of aromatic polyphosphonic acid membranes and polyelectrolyte-polyphosphonic acid blend membranes via ionically crosslinking in-situ formation of polyvalent metal polyphosphonates, and also membranes comprising the metal polyphosphonates mentioned, and also further uses of the oligomeric or polymeric siloxanes of the invention comprising phosphonic acid groups and/or of the oligomeric or polymeric siloxanes of the invention comprising silyl polyphosphonate and/or alkyl polyphosphonate groups or of blends according to the invention for the binding of metal ions, for aiding or improving contact between materials selected from the group consisting of the following classes of substances: metals, plastics and further materials, e.g. apatites, in or as corrosion-inhibiting metal coatings and also as acid catalysts.

Oligomeric or polymeric siloxanes comprising phosphonic acid groups or phosphonic ester groups can be used in many fields. They can, for example, be used as slip coatings on metals and textiles, flame-inhibiting additives, bonding agents, additives for cosmetics or laundry detergents, antifoams, release agents, damping liquids, liquids for heat transfer, antistatics, polishes and coatings, in or as membranes, films or composites, in particular in or as membranes in fuel cells or in separation technology and for the binding of metal ions.

Thus, WO 2005/005519 relates to a process for preparing silicones modified with phosphonic esters. The silicones modified with phosphonic esters are prepared by reaction of silanes comprising phosphonic ester groups with reactive silicon compounds.

WO 2005/036687 relates to water-insoluble additives for improving the performance of ion exchange membranes, with these additives being able to be made up of a siloxane matrix modified with phosphonic acid groups. The siloxane matrix is preferably a cross-linked siloxane matrix which bears phosphonic acid groups bound covalently via linkers. The preparation of these crosslinked siloxanes functionalized with phosphonic acid groups bound via a linker is carried out, according to WO 2005/036687, by reaction of a silane with a further silane bearing a phosphonato group bound to the silane via a linker in water and in the presence of a catalytic amount of a concentrated acid. Heating this reaction mixture results in formation of a gel which subsequently becomes solid on further heating and forms a crosslinked phosphonate ester as intermediate. Acid hydrolysis of the crosslinked phosphonate ester gives the desired siloxane functionalized with phosphonic acid groups.

According to the abovementioned documents, the phosphonic acid function is bound to the siloxane skeleton via linkers comprising aliphatic units. The oligosiloxanes and polysiloxanes are prepared by condensation of siloxane compounds comprising phosphonic acid derivatives, or with cocondensation with compounds which are free of phosphonic acid derivatives also being possible in order to modify the solubility and the mechanical properties.

It is an object of the present invention to provide further oligomeric or polymeric siloxanes which comprise phosphonic acid groups and have a controlled content of phosphonic acid groups and can be obtained by a process which is simple to carry out. The oligomeric or polymeric siloxanes comprising phosphonic acid groups should be suitable, in particular, for use in membranes for fuel cells, for example as additives. In addition, the oligomeric or polymeric siloxanes comprising phosphonic acid groups should be suitable for applications in which such functionalized siloxanes are usually employed.

This object is achieved by oligomeric or polymeric siloxanes comprising phosphonic acid groups and comprising one or more units of the general formula (I)

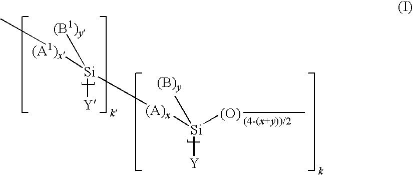

where
Y and Y′ are each, independently of one another,

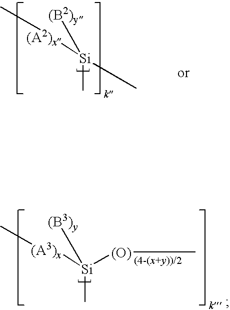

A, A¹, A², A³ are each, independently of one another,

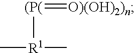

B, B¹, B², B³ are each, independently of one another,

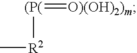

x, y,
x′, y′,
x″, y″,
x′″, y′″ are each, independently of one another, 0, 1 or 2, with the proviso that the sums (x+y), (x′+y′), (x″+y″) and (x′″+y′″) are each not more than 3;
m, n are each, independently of one another, 0, 1 or 2; but are not simultaneously 0;
k is an integer ≧2,
k′, k″, k′″ are each from 0 to 4, preferably from 0 to 2, particularly preferably 0;
R¹ is a divalent or polyvalent aromatic radical which apart from optionally one or more radicals (P(═O)(OH)₂) may bear one or more further substituents and/or comprise one or more heteroatoms;
R² is an aryl or alkyl group which apart from optionally one or more radicals (P(═O)(OH)₂) may bear one or more further substituents and/or bear one or more heteroatoms;
   where Y and Y′ can be bound via an Si atom, the group A³ or an O atom and via an Si atom or the group A², respectively, to an Si atom of the compounds of the general formula I.

The oligomeric or polymeric siloxanes of the invention comprising phosphonic acid groups have a linear, linear ladder-like, cage-like or crosslinked siloxane matrix which has silicon atoms which are crosslinked via a plurality of disiloxy bonds (Si—O—Si). At least some of the silicon atoms are covalently linked to radicals comprising phosphonic acid groups.

The oligomeric or polymeric siloxanes of the invention comprising phosphonic acid groups can in principle be organic or inorganic hybrid oligo(siloxanes), poly(siloxanes), oligosilsesquisiloxanes or polysilsesquisiloxanes and polyhydral silsesquisiloxanes. In a preferred embodiment, the oligomeric or polymeric siloxane skeleton is a silsesquisiloxane, i.e. the siloxanes of the invention are silsesquisiloxanes comprising phosphonic acid groups. Silsesquisiloxanes are a specific group of siloxanes which generally have a composition of the general formula Si₂ₙO₃ₙR₂ₙ, where R can in principle be Cl, H or another substituent, for example a hydrocarbon radical. In silsesquisiloxanes, each Si atom is bound via an O atom to three further silicon atoms. The silsesquisiloxanes can be in the form of an unstructured matrix, in the form of ladder-like structures or in the form of completely or partly closed cage-like polyhedral structures.

For the purposes of the present patent application, the term alkyl refers to a linear or branched alkyl radical which generally has from 1 to 20, preferably from 1 to 8, particularly preferably from 1 to 6, very particularly preferably from 1 to 4, carbon atoms and in the case of R² in formula (I) optionally bears one or more radicals (P(═O)(OH)₂). In the alkyl radicals for the purposes of the present patent application, it is also possible for the carbon chain of the alkyl group to be interrupted by heteroatoms or heteroatom-comprising groups, for example by 0 or by NR³, where R³ can in turn be alkyl, alkenyl, cycloalkyl, aryl or aralkyl. Suitable alkyl groups are, for example, methyl, ethyl, n-propyl, i-propyl, n-butyl, s-butyl, t-butyl, 1-pentyl, t-pentyl, 1-hexyl, 1-octyl, i-octyl, t-octyl, 2-ethylhexyl, nonyl, decyl, undecyl, dodecyl, tridecyl, tetradecyl, pentadecyl, hexadecyl, heptadecyl, octadecyl, nonadecyl, eicosyl, 1,4-tetramethylene, where the alkyl radicals in the case of R² in formula (I) are optionally substituted by one or more radicals (P(═O)(OH)₂). The alkyl groups can also be substituted by alkenyl, cycloalkyl, aryl or aralkyl or heteroatoms or heteroatom-comprising groups, e.g. halogens or halogen-comprising groups.

For the purposes of the present patent application, the term alkenyl refers to groups which can be linear or branched and have from 2 to 20, preferably from 2 to 8, particularly preferably from 2 to 6, very particularly preferably from 2 to 4, carbon atoms. The carbon chains of the alkenyl groups can also be interrupted by heteroatoms, for example, by O or NR³, where R³ has been defined above. The alkenyl groups can also be substituted by the groups mentioned in respect of the alkyl groups.

Suitable alkenyl groups are, for example, butenyl, hexenyl, octenyl in all isomeric forms.

For the purposes of the present patent application, cycloalkylenes are substituted and unsubstituted cycloalkyl groups having from 3 to 20, preferably from 3 to 12, particularly preferably from 3 to 6, carbon atoms in the cyclic skeleton. Suitable substituents of the cycloalkyl groups are the substituents mentioned above in respect of the alkyl groups. It is also possible for one or more carbon atoms of the cyclic skeleton to be replaced by heteroatoms or heteroatom-comprising groups, for example O, S or NR³, where R³ has been defined above. Suitable cycloalkyl groups are, for example, 1-cyclooctyl, 1-cycloheptyl, 1-cyclohexyl, 1-cyclopentyl, 1-methylcyclopentyl, 1-methylcyclohexyl, 1-methyl-4-i-propylcyclohexyl, preferably 1-cyclopentyl, 1-cyclohexyl and 1-cyclooctyl.

For the purposes of the present patent application, aryl groups are substituted and unsubstituted aryl groups which in the case of R² optionally bear one or more radicals (P(═O)(OH)₂). The aryl groups preferably have from 6 to 20, particularly preferably from 6 to 12, carbon atoms in the basic skeleton. Aryl groups also include groups in which 2 or more aryl groups are linked via one or more single bonds, for example, biphenyl. Suitable substituents, apart from optionally one or more radicals (P(═O)(OH₂) in the case of R² in formula (I), have been mentioned above in respect of the alkyl radicals. One or more of the carbon atoms of the skeleton can be replaced by heteroatoms, for example O, S or N. Preferred aryl groups are phenyl, naphthyl, biphenyl and phenoxyphenyl, which in the case of R² in formula may optionally be substituted by one or more radicals (P(═O)(OH)₂).

Suitable aralkyl groups for the purposes of the present patent application are substituted or unsubstituted aralkyl groups having from 7 to 20, preferably from 7 to 18, particularly preferably from 7 to 14, carbon atoms in the aralkyl radical. It is possible for one or more of the carbon atoms in the aryl radical of the aralkyl radical or in the alkyl radical of the aralkyl radical to be replaced by heteroatoms or heteroatom-comprising groups, for example O or NR³, where R³ has been defined above. Furthermore, the aralkyl groups may be substituted by the substituents mentioned in the respect of alkyl groups. Suitable aralkyl groups are, for example, m/p-phenylethyl, benzyl, m/p-tolyl and i-xylyl.

For the purposes of the present patent application, divalent or polyvalent aromatic radicals are substituted or unsubstituted radicals which in the case of R¹ in formula (I) are optionally substituted by one or more radicals (P(═O)(OH)₂). The divalent or polyvalent aromatic radicals can further comprise heteroatoms, for example N, O or S. Apart from the radicals (P(═O)(OH)₂) which are optionally comprised in the radical R¹ in formula (I), the divalent or polyvalent aromatic radicals may comprise further substituents, with suitable substituents being the substituents mentioned above in respect of the alkyl radicals. Preferred radicals are divalent aromatic radicals which in the case of R¹ in formula (I) may optionally bear one or more radicals (P(═O)(OH)₂). Suitable divalent radicals are, for example, arylene radicals such as 1,4-phenylene, 1,3-phenylene, 1,2-phenylene, 1,6-naphthylene, 2,4-naphthylene, 2,6-carbazole, 3-phenyl-1,4-arylene, 3-alkyl-1,4-arylene, 2-alkyl-1,4-arylene, 2-alkoxy-1,4-arylene, 3-alkoxy-1,4-arylene, 2,4-dimethyl-1,4-phenylene, 2,3,5,6-tetramethyl-1,4-phenylene, 4,4′-biphenylene, 3,3′-diphenyl-4,4′-biphenylene or arylenealkyls, for example 2,2′-isopropylidenebis(1,4-phenylene). These radicals are in the case of R¹ in formula (I) optionally substituted by one or more radicals (P(═O)(OH)₂). Suitable alkyl radicals for the purposes of the present patent application have been mentioned above. Suitable alkoxy radicals for the purposes of the present patent application are ones which comprise the above-mentioned alkyl radicals. Very particularly preferred divalent aromatic radicals are, apart from R¹ in formula (I) which may optionally be substituted by one or more radicals (P(═O)(OH)₂), unsubstituted. Particularly preferred radicals are 1,4-phenylene, 1,3-phenylene, 1,2-phenylene, 2,2′-isopropylidenebis(1,4-phenylene), 4,4′-biphenylene, 3,3′-diphenyl-4,4′-biphenylene, which may, as mentioned above, in the case of R¹ in formula (I) be substituted by one or more radicals (P(═O)(OH)₂).

In the oligomeric or polymeric siloxanes of the invention comprising phosphonic acid groups and comprising one or more units of the general formula (I), k in the general formula (I) is an integer ≧2. In a preferred embodiment, in the case of completely or partly closed cage-like polyhedral silsesquisiloxanes, k is particularly preferably 6, 8, 10 or 12.

k′, k″ and k′″ in the oligomeric or polymeric siloxanes of the invention comprising phosphonic acid groups and comprising one or more units of the general formula (I) are each from 0 to 4, preferably from 0 to 2, particularly preferably 0, as long as the solubility of the compounds of the invention is not adversely affected.

x and y in the units of the general formula (I) are each 0, 1 or 2, with the proviso that the sum (x+y) is not more than 3 and x and y are not simultaneously 0. The sum (x+y) is preferably 1 or 2, particularly preferably 1. When the sum (x+y) is 3, x is 1 and y is 2 in a preferred embodiment and x is 2 and y is 1 in a further embodiment. If the sum (x+y) is 2, x and y are each 1 in a preferred embodiment. x′, x″, x′″ and y′, y″, y′″ in the units of the general formula I are each 0, 1 or 2, with the proviso that the sums (x′+y′) and (x″+y″) and (x′″+y′″) are each not more than 3.

In addition, the siloxanes of the invention can have mixed structures in which x and y are each 0.

m and n in the groups A and B of the units of the general formula (I) are each, independently of one another, 0, 1 or 2, with at least m or n being different from 0 in at least one of the k units of the formula (I). Preference is given to n and m each being, independently of one another, 1 or 2, in general as long as the solubility or dispersibility is not adversely affected by aggregation.

In a preferred embodiment of the present invention, the siloxanes of the invention comprising phosphonic acid groups thus have a silsesquisiloxane skeleton, with the silsesquisiloxanes being completely or partly closed cage-like polyhedral silsesquisiloxanes in which k in the general formula (I) is particularly preferably 6, 8, 10 or 12.

In a preferred embodiment, the radical R² is an aryl group which apart from optionally one or more radicals (P(═O)(OH)₂) may bear one or more further substituents and/or may comprise one or more heteroatoms, with preferred aryl groups R² having been mentioned above.

Particular preference is given to oligomeric or polymeric siloxanes comprising phosphonic acid groups and comprising one or more units of the general formula (I) in which the radical R¹ in at least one of the units k bears one or more radicals (P(═O)(OH)₂).

In a further preferred embodiment, the siloxanes of the invention comprising phosphonic acid groups are silsesquisiloxanes which are ladder-like or unstructured and in which x is 1 and y is 0. The radical R¹ in the latter-like or unstructured silsesquisiloxanes is particularly preferably phenylene.

In a very particularly preferred embodiment, the present invention provides oligomeric or polymeric siloxanes which comprise phosphonic acid groups and have the general formula I in which k′, k″ and k′″ are each 0, i.e. polymeric siloxanes comprising one or more units of the general formula (Ia)

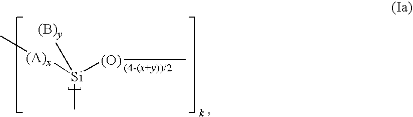

where the symbols and indices in the compound of the formula Ia are as defined above.

The symbols and indices in the compounds of the general formula Ia preferably have the following meanings:

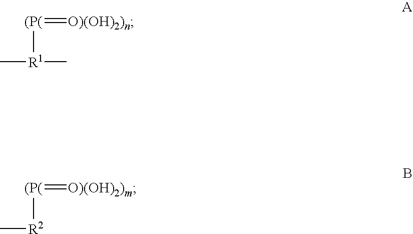

x, y are each 0, 1 or 2, with the proviso that the sum (x+y) is not more than 3;
m, n are each, independently of one another, 0, 1 or 2 but are not simultaneously 0;
k is 6, 8, 10 or 12;
R¹ is phenylene, biphenylene, phenoxyphenylene or naphthylene;
R² is phenylene, biphenylene, phenoxyphenylene or naphthylene.

The oligomeric or polymeric siloxanes of the invention comprising phosphonic acid groups and comprising one or more units of the general formula (I) generally have a molecular weight of from 400 to 5000, preferably from 1000 to 3000, particularly preferably from 1200 to 2600. Furthermore, relatively high molecular weight ladder-like structures comprising one or more units of the general formula (I) and having molecular weights higher than those indicated above are comprised by the present invention.

In a further embodiment of the present invention, the oligomeric or polymeric siloxanes comprising phosphonic acid groups consist exclusively of units of the general formula (I). In this case, at least one of the units of the general formula (I) has a group A, B, A¹, B¹, A² and/or B², preferably at least one group A or B, according to formula (I) in which n and/or m are different from 0. The oligomeric or polymeric siloxane comprising phosphonic acid groups and comprising one or more units of the general formula (I), with the siloxane of the invention consisting exclusively of units of the formula (I) in a preferred embodiment, preferably has a degree of functionalization in respect of the amount of radicals (P(═O)(OH)₂) of generally at least 25%, preferably at least 35%, particularly preferably at least 45%, very particularly preferably at least 50%.

Here, a degree of functionalization of at least 50% means that at least 50% of the repeating units k are substituted by phosphonic acid groups (P(═O)(OH)₂).

The degree of phosphonylation can be determined by means of conventional methods, for example by means of weighing, by means of NMR spectroscopy or by means of elemental analysis. These methods are known to those skilled in the art.

The oligomeric or polymeric siloxanes of the invention comprising phosphonic acid groups and comprising one or more units of the general formula (I) are generally halogen-free. For the purposes of the present patent application, halogen-free means that the content of halogen in the oligomeric or polymeric siloxanes comprising phosphonic acid groups and comprising one or more units of the general formula (I) is less than 10% by weight, preferably less than 5% by weight, particularly preferably less than 3% by weight, in each case based on the mass of the oligomeric or polymeric siloxane comprising phosphonic acid groups and comprising one or more units of the general formula (I).

The oligomeric or polymeric siloxanes of the invention comprising phosphonic acid groups and comprising one or more units of the general formula (I) are generally pre-pared by phosphonylation of the corresponding oligomeric or polymeric siloxanes.

The present invention therefore further provides a process for preparing oligomeric or polymeric siloxanes comprising phosphonic acid groups, which comprises the step:
(i) phosphonylation of halogenated oligomeric or polymeric siloxanes comprising one or more units of the formula (II)

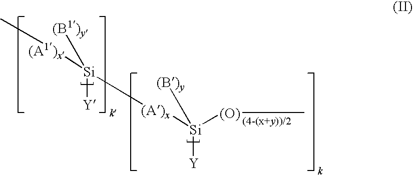

where
Y and Y′ are each, independently of one another,

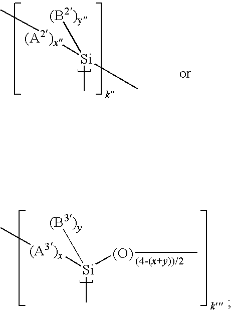

A′, A^{1′}, A^{2′}, A^{3′} are each, independently of one another,

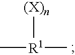

B′, B^{1′}, B^{2′}, B^{3′} are each, independently of one another,

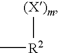

x, y,
x′, y′,
x″, y″,
x′″, y′″ are each, independently of one another, 0, 1 or 2, with the proviso that the sums (x+y), (x′+y′), (x″+y″) and (x′″+y′″) are each not more than 3;
m, n are each, independently of one another, 0, 1 or 2; but are not simultaneously 0;
k is an integer ≧2, where x and y are not simultaneously 0 in at least one of the units of the formula (II);
k′, k″, k′″ are each from 0 to 4, preferably from 0 to 2, particularly preferably 0;
R¹ is a divalent or polyvalent aromatic radical which may optionally bear one or more further substituents and/or comprise one or more heteroatoms;
R² is an aryl or alkyl group which may optionally bear one or more further substituents and/or comprise one or more heteroatoms;
X, X′ are each halogen, preferably Br, I, particularly preferably Br;
   where Y and Y′ can be bound via an Si atom, the group A³ or an O atom and via an Si atom or the group A², respectively, to an Si atom of the compounds of the general formula I;
   by means of silyl and/or alkyl phosphites in the presence of a catalyst, with the phosphonylation being carried out in a nitrogen-free solvent at temperatures of ≧150° C.

In a preferred embodiment, the oligomeric or polymeric siloxanes of the invention comprising phosphonic acid groups and comprising one or more units of the general formula (I) are prepared by means of the process of the invention. The groups and indices x, x′, x″, x′″, y, y′, y″, y′″, m, n, k, k′, k″, k′″, R¹ and R² therefore correspond to the embodiments mentioned in respect of the oligomeric or polymeric siloxanes comprising phosphonic acid groups and comprising one or more units of the general formula (I).

The preparation of oligomeric or polymeric siloxanes comprising phosphonic acid groups and comprising one or more units of the general formula (I) by subsequent phosphonylation of the corresponding halogenated oligomeric or polymeric siloxanes by means of silyl and/or alkyl phosphites has hitherto not been described in the prior art. The process of the invention makes it possible to set the degree of phosphonylation of the oligomeric or polymeric siloxanes in a targeted manner and to achieve arylsiloxane functionalization, i.e., in a preferred embodiment of the present invention, the phosphonic acid groups are not bound to one or more silicon atoms of the siloxane skeleton via a linker made up of aliphatic units but via radicals comprising aromatic units.

It has surprisingly been found that the synthesis of structurally defined oligomeric or polymeric siloxanes comprising phosphonic acid groups and comprising one or more units of the general formula (I) can readily be achieved by subsequent catalytic phosphonylation of halogenated, appropriately structured siloxanes. The siloxane matrix is not destroyed or damaged in the phosphonylation process of the invention.

In one embodiment of the process of the invention, silyl phosphites are used for phosphonylation. These preferably have the general formula (III) or (IV),

P(OSiR⁴R⁵R⁶)(OSiR⁷R⁸R⁹)(OSiR¹⁰R¹¹R¹²) (III)

or

P(OSiR⁴R⁵R⁶)OSiR⁷R⁸R⁹)(OH) (IV)

where

### R⁴, R⁵, R⁶, R⁷, R⁸, R⁹, R¹⁰, R¹¹, R¹²

are each, independently of one another, alkyl, alkenyl, cycloalkyl, aralkyl, aryl, with the abovementioned groups being able to be substituted and/or being able to comprise heteroatoms.

As an alternative, the silyl phosphites are mixtures of O-silylated phosphorous esters which are obtainable by silylation of phosphorous acid by means of one or more aminosilanes, halosilanes and/or alkoxysilanes.

In a further embodiment of the process of the invention, the phosphonylation is carried out using alkyl phosphites which preferably have the general formula (V) or (VI),

P(OR¹³)(OR¹⁴)(OR¹⁵) (V)

or

P(OR¹³)(OR¹⁴)(OH) (VI)

where

### R¹³, R¹⁴, R¹⁵

are each, independently of one another alkyl, alkenyl, cycloalkyl, aralkyl, with the above-mentioned groups being able to be substituted and/or being able to comprise heteroatoms.

It is likewise possible to use mixtures of the abovementioned silyl phosphites of the general formula (III) or (IV) and the abovementioned alkyl phosphites of the general formula (V) or (VI) for the phosphonylation.

In a preferred embodiment of the present invention, silyl phosphites having the general formulae P(OSiR⁴R⁵R⁶)₃ and/or P(OSiR⁴R⁵R⁶)₂(OH) are used in the process of the invention. In the general formulae (III) and (IV) in this preferred embodiment, R⁷ and R¹⁰ are identical to R⁴, R⁸ and R¹¹ are identical to R⁵ and R⁹ and R¹² are identical to R⁶.

Suitable alkyl, alkenyl, cycloalkyl, aralkyl and aryl radicals have been mentioned above.

The radicals R⁴, R⁵, R⁶, R⁷, R⁸, R⁹, R¹⁰, R¹¹ and R¹² are preferably selected independently from among linear or branched C1-C20-alkyl, alkenyl and aryl radicals, preferably methyl, ethyl, n-propyl, i-propyl, n-butyl, 1-(but-3-enyl), s-butyl, t-butyl, 1-pentyl, t-pentyl, 1-hexyl, 1-octyl, i-octyl, t-octyl, 2-ethylhexyl, 1-cyclooctyl, 1-cycloheptyl, 1-cyclohexyl, 1-cyclopentyl, 1-methylcyclopentyl, 1-methylcyclohexyl, 1-methyl-4-i-propylcyclohexyl, nonyl, decyl, undecyl, dodecyl, tridecyl, tetradecyl, pentadecyl, hexadecyl, heptadecyl, octadecyl, nonadecyl, eicosyl, phenyl, biphenyl, 1,3-tetramethylene and —(CH₂CH₂)ₙOCH₃ where n=an integer from 1 to 100, preferably from 1 to 10.

The silyl phosphites used in one embodiment of the process of the invention can be prepared by methods known to those skilled in the art, for example by silylation of phosphorous acid by means of one or more aminosilanes, halosilanes or alkoxysilanes, and some of them are commercially available.

In a particularly preferred embodiment, tris(trimethylsilyl) phosphite is used as silyl phosphite.

The radicals R¹³, R¹⁴ and R¹⁵ used in the alkyl phosphites of the formula (V) or (VI) used in a further embodiment of the process of the invention are preferably likewise selected from among the radicals mentioned in respect of the radicals R⁴, R⁵, R⁶, R⁷, R⁸, R⁹, R¹⁰, R¹¹ and R¹². In a particularly preferred embodiment, the radicals R¹³, R¹⁴ and R¹⁵ of the alkyl phosphites have the same meanings. Very particular preference is given to using triethyl phosphite and tributyl phosphite or diethyl phosphite as alkyl phosphites.

The alkyl phosphites which can be used in an embodiment of the process of the invention are prepared by methods known to those skilled in the art, and some of the alkyl phosphites are also commercially available.

The process of the invention for preparing the oligomeric or polymeric siloxanes of the invention comprising phosphonic acid groups is carried out in the presence of a catalyst. In a preferred embodiment, the catalyst comprises at least one metal selected from the group consisting of Ni, Pd, Pt, Rh, Ru, Os and Ir, preferably Ni and Pd. It is likewise possible for the catalyst to comprise mixtures of two or more of the metals mentioned. Nickel and palladium can here be present in the oxidation states 0 to +2, i.e., in a preferred embodiment, either nickel and/or palladium salts or complexes of nickel and/or palladium are used. If a catalyst comprising palladium is used, a silyl phosphite of the formula (IV) or an alkyl phosphite of the formula (VI) is generally used. When a nickel-comprising catalyst is used, a silyl phosphite of the formula (III) or an alkyl phosphite of the formula (V) is generally used.

Suitable salts of nickel and/or palladium are halides, preferably chlorides, bromides or iodides, particularly preferably chlorides, pseudohalides, preferably cyanides, OCN, SCN, particularly preferably cyanides, β-diketonates, preferably acetylacetonates. Preferred salts of nickel are nickel(II) salts. If nickel(0) complexes are used, preference is given to Ni[CO]₄, Ni[P(OR)₃]₄, where R is a linear or branched C₁-C₂₀-alkyl radical, preferably ethyl, as disclosed, for example, in J. Org. Chem. 1980, 45, 5426 to 5429.

Suitable Pd(0) complexes are, for example, triphenylphosphine complexes or dibenzylideneacetonates. Examples are tetrakis(triphenylphosphine)palladium and tris(dibenzylideneacetone)palladium.

In a preferred embodiment of the process of the invention, a catalyst comprising nickel, preferably Ni(0) or Ni(II), in particular a catalyst comprising nickel in the form of a nickel(II) salt, is used. Suitable salts have been mentioned above. Particular preference is given to using a nickel(II) halide, in particular NiCl₂ as catalyst in the process of the invention.

The catalyst is generally used in an amount of from 0.01 to 1 molar equivalent, based on the number of molar equivalents of the halogen in the halogenated oligomeric or polymeric siloxanes comprising one or more units of the formula (II), in each case based on the amount of the metal used.

In the process of the invention, virtually complete conversion of the halogenated oligomeric or polymeric siloxanes comprising one or more units of the formula (II) into the corresponding oligomeric or polymeric siloxanes comprising phosphonic acid groups and comprising one or more units of the formula (I) occurs even in the presence of small amounts of the catalyst used, with oligomeric or polymeric siloxanes functionalized with phosphonic acid groups generally being obtained.

The precise amount of the catalysts used is dependent, inter alia, on whether the phosphonylation is carried out using silyl phosphites or alkyl phosphites and on the metal used in the catalyst.

If the phosphonylation is carried out by the process of the invention using silyl phosphites, the amount of catalyst used is preferably from 0.01 to 0.2 molar equivalent, based on the number of molar equivalents of the halogen in the halogenated oligomeric or polymeric siloxanes comprising one or more units of the formula (II), particularly preferably from 0.01 to 0.1 molar equivalent, if a catalyst comprising nickel is used.

If a catalyst comprising palladium is used when using silyl phosphites for the phosphonylation, the catalyst is preferably used in an amount of from 0.025 to 0.5 molar equivalent, based on the number of molar equivalents of the halogen in the halogenated oligomeric or polymeric siloxanes comprising one or more units of the formula (II).

If an alkyl phosphite is used for the phosphonylation in the process of the invention, the amount of the preferred nickel catalyst is preferably from 0.05 to 0.5 molar equivalent, based on the number of molar equivalents of the halogen in the halogenated oligomeric or polymeric siloxanes comprising one or more units of the formula (II), particularly preferably from 0.05 to 0.2 molar equivalent.

In the process of the invention, nitrogen-free solvents are used as solvents. A single solvent or a mixture of solvents can be employed. The nitrogen-free solvent or the mixture of nitrogen-free solvents preferably has a boiling point above 150° C. Suitable solvents are selected from the group consisting of diphenyl ethers, benzophenone, diphenyl sulfone, sulfolane, the alkyl- or alkoxy-substituted derivatives of these compounds, in particular the methyl-, ethyl-, propyl-, butyl-, methoxy-, ethoxy-, propoxy-, butoxy-substituted derivatives, aliphatic, partly aromatic, aromatic oligoethers and polyethers, aliphatic, partly aromatic, aromatic β-diketones, for example acetylacetone, acetylbenzophenone and 1,3,H-diphenylpropane-1,3-dione, the alkyl-, alkoxy-, aryl- and aryloxy-substituted derivatives of these compounds, aliphatic, partly aromatic, aromatic keto ethers, the alkyl-, alkoxy-, aryl-, aryloxy-substituted derivatives of these compounds, aliphatic, partly aromatic, aromatic carboxylic esters and aliphatic, partly aromatic, aromatic carbonates, alkyl-, alkoxy-, aryl- and aryloxy-substituted derivatives of these compounds, and mixtures of the abovementioned solvents. Preferred solvents are benzophenone, diphenyl ether and diphenyl sulfone, and dimethyl-, ethyl-, propyl-, butyl-, methoxy-, ethoxy-, propoxy-, butoxy-substituted derivatives of these compounds. Very particular preference is given to using diphenyl ether and benzophenone.

The reaction temperature in the process of the invention is, according to the invention, ≧150° C. The process of the invention is preferably carried out at temperatures of from 150 to 250° C., particularly preferably from 170 to 250° C., very particularly preferably from 190 to 250° C.

The solvent is used in a ratio to the halogenated oligomeric or polymeric siloxanes comprising one or more units of the formula (II) used in the process of the invention of generally 5 to 300% by weight:5 to 200% by weight, preferably 5 to 100% by weight:5-50% by weight, particularly preferably 5-25% by weight.

A preferred embodiment of the process of the invention for the phosphonylation of halogenated oligomeric or polymeric siloxanes comprising one or more units of the formula (II) is described by way of example below. To carry out the phosphonylation, the halogenated oligomeric or polymeric siloxane comprising one or more units of the formula (II) together with a catalyst, preferably one of the abovementioned catalysts, particularly preferably a nickel- or palladium-comprising catalyst, in the above-mentioned amount are placed in a sufficiently large reactor, preferably glass reactor, and freed of moisture at the abovementioned temperatures by passing a stream of nitrogen over the mixture for a number of hours, for example from two to four hours. This gas stream is preferably maintained during the entire duration of the reaction, as a result of which volatile reaction products can be removed. After addition of the desired amount of solvent, with suitable amounts and solvents having been mentioned above, a solution is produced by stirring at the abovementioned temperatures. The phosphorus component, i.e. the silyl phosphite and/or alkyl phosphite, with preferred silyl and alkyl phosphites having been mentioned above and tris(trimethylsilyl) phosphite or triethyl phosphite being very particularly useful, is then added dropwise to the homogeneous mixture at such a rate that the total amount is preferably introduced into the mixture over a period of from 15 to 60 minutes, particularly preferably from 30 to 45 minutes. If appropriate, the reaction temperature is increased further within the above-mentioned temperature range after commencement of the dropwise addition until a color change is visible, if this does not become visible without an increase in the temperature. In general, the appearance of the color change is accompanied by the occurrence of a colorless liquid which is carried from the reaction vessel by the N₂ stream and vigorous foaming. After a reaction time of generally from 1 to 12 hours, preferably from 1 to 8 hours, particularly preferably from 1 to 4 hours, the reaction mixture is cooled slightly (within the abovementioned temperature ranges) and is maintained at this temperature for a period of generally from 4 to 24 hours, preferably from 4 to 12 hours, particularly preferably from 4 to 8 hours.

After the reaction is complete, the mixture is taken up in a suitable low-boiling solvent, for example tetrahydrofuran, and freed of solvent, reaction residues and catalyst by precipitation in an alcohol, preferably methanol. If a silyl phosphite has been used for the phosphonylation, the silyl ester is generally at the same time cleaved by alcoholysis to form phosphonic acid. The amount of alcohol used for this purpose is generally from 3 to 20 times the weight of the mixture. An improved removal of the catalyst can be achieved by, for example, acidification of the alcoholysis bath with from 0.1 to 5% by volume of a strong mineral acid, preferably concentrated HCl, HBr or dilute HNO₃. The alcohol is generally replaced after a time of from 15 to 240 minutes, preferably from 30 to 180 minutes, particularly preferably from 30 to 120 minutes, and this procedure is repeated a number of times, for example from 3 to 10 times. The purification and alcoholysis step can be made more intensive by simultaneous action of ultrasound or by means of Soxhlet extraction of the mixture with a weakly acidic alcohol comprising from 0.1 to 5% by volume of a strong mineral acid, with preferred strong mineral acids having been mentioned above, for generally from 4 to 96 hours, preferably from 12 to 48 hours. As alternatives to this simultaneous process of purification and ester cleavage in the case of a phosphonylation by means of silyl phosphites, there are further possibilities for the purification and ester cleavage. For example, simultaneous purification and ester cleavage by repeated dissolution and precipitation of the reaction product in a suitable solvent and acidic precipitant is also possible.

The halogenated oligomeric or polymeric siloxanes comprising one or more units of the formula (II) are generally prepared by reacting the corresponding oligomeric or polymeric siloxanes with a halogenating agent. Preferred oligomeric or polymeric siloxanes comprise units of the general formula (VII)

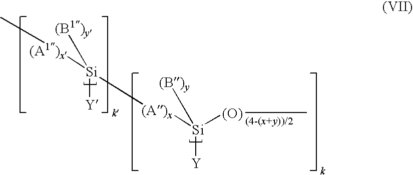

where
Y and Y′ are each, independently of one another,

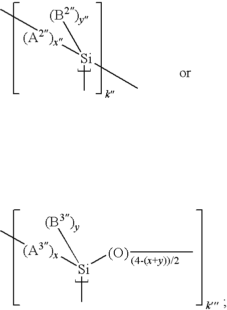

A″, A^{1″}, A^{2″}, A^{3″} are each, independently of one another,

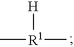

B″, B^{1″}, B^{2″}, B^{3″} are each, independently of one another,

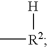

x, y,
x′, y′,
x″, y″,
x′″, y′″ are each, independently of one another, 0, 1 or 2, with the proviso that the sums (x+y), (x′+y′), (x″+y″) and (x′″+y′″) are each not more than 3;
k is an integer ≧2;
k′, k″, k′″ are each from 0 to 4, preferably from 0 to 2, particularly preferably 0;
R¹ is a divalent or polyvalent aromatic radical which may optionally bear one or more further substituents and/or comprise one or more heteroatoms;
R² is an aryl or alkyl group which may optionally bear one or more further substituents and/or comprise one or more heteroatoms;
   where Y and Y′ can be bound via an Si atom, the group A³ or an O atom and via an Si atom or the group A², respectively, to an Si atom of the compounds of the general formula I.

Preferred indices x, x′, x″, x′″, y, y′, y″, y′″ and k, k′, k″, k′″ and also preferred radicals R¹ and R² have been mentioned above.

The halogenation of the compounds of the general formula (VII) is generally carried out at a temperature of from −20 to 140° C., preferably from 20 to 140° C., particularly preferably from 25 to 100° C. The halogenation is usually carried out in an inert solvent. Suitable inert solvents are, for example, alkylcarboxylic acids, chlorinated hydrocarbons, inorganic acids such as sulfuric acid, alkylsulfonic acid or mixtures thereof.

Suitable halogenating agents are known to those skilled in the art. Preference is given to carrying out a bromination or iodination. Preferred brominating agents are elemental bromine and N-bromo compounds such as N-bromosuccinimide or dibromoisocyanuric acid.

The desired degree of halogenation can be controlled via the time for which the halogenating agent used is allowed to act, the molar ratio of halogenating agent to the oligomeric or polymeric siloxane and the temperature. In general, a degree of halogenation of from 25 to 150%, preferably from 50 to 125%, particularly preferably from 50 to 100%, is set.

The degree of halogenation, in particular the degree of bromination, can be determined by means of conventional methods, for example by weighing, by NMR spectroscopy or by elemental analysis. These methods are known to those skilled in the art.

The amounts of brominated siloxane and solvent in the reaction mixture obtained are generally from 0.1 to 99.9% by weight of siloxane and from 0.1 to 99.9% by weight of solvent.

The proportion of siloxane in the reaction mixture is preferably from 3 to 95% by weight, with a high proportion of siloxane of usually at least 80% by weight, particularly preferably at least 90% by weight, being particularly preferred.

The oligomeric or polymeric siloxanes, preferably oligomeric or polymeric siloxanes comprising units of the general formula (VII), used as starting compounds can be prepared according to methods known to those skilled in the art by condensation of reactive silicon compounds. The structures formed, degrees of polymerization and homogeneities of the oligomeric or polymeric siloxanes obtained, in particular the oligomeric or polymeric siloxanes comprising units of the general formula (VII) obtained, can be influenced to a large extent by means of the solvents used, the reactive silicon compounds used as starting materials, the temperature, concentration, the catalysts used and the type and molar ratios of any condensation partners. Suitable processes for preparing oligomeric or polymeric siloxanes are disclosed, for example, in J. Inorg. Organomet. Poly., 2001, 11(3), 123 to 154; J. Inorg. Organomet. Poly., 1998, 8(1), 1 to 21; Inorg. Chem., 30, 5, 1991, 881 to 882; J. Mater. Chem., 2000, 10, 1811 to 1818; Chem. Commun., 1999, 81 to 82; U.S. Pat. No. 3,000,858, J. Organomet. Chem. 1989, 379, 33 to 40; J. Chem. Soc., Dalton Trans., 2003, 2945 to 2949; Poly. J., 1997, 29(8), 678 to 684; J. Chem. Soc. Dalton Trans., 1999, 1491 to 1497, J. Am. Chem. Soc., 1964, 86, 1120 to 1125.

A process for the bromination of [phenyl-SiO_{1.5}]₈ (prepared as described in J. Am. Chem. Soc. 1994, 86, 1120 to 1125) is described by way of example below. The oligomeric siloxane [phenyl-SiO_{1.5}]₈ is suspended in tetrachlorethane or dissolved at elevated temperature in 1,2,4-trichlorobenzene and is brominated at elevated temperature by addition of elemental bromine diluted with an inert solvent at a temperature from room temperature to reflux temperature while stirring. The degree of bromination can be controlled by setting of a particular bromine/siloxane molar ratio, the temperature and via the reaction time. To stop the reaction, the mixture is precipitated in a cooled nonsolvent such as acetone, methanol or i-hexane or a mixture thereof, filtered off with suction, washed with a little aliphatic alcohol having from 1 to 6 carbon atoms, preferably methanol, preferably until free of bromine, and dried.

The degree of bromination achieved by means of the abovementioned process can be determined in a manner known to those skilled in the art, for example by weighing, ¹H-NMR, elemental analysis of the C or Br content and by mass-spectroscopic methods such as MALDI-TOF.

In step (i) of the process of the invention, halogenated oligomeric or polymeric siloxanes comprising one or more units of the formula (II) are phosphonylated by means of silyl phosphites and/or alkyl phosphites to give the corresponding oligomeric or polymeric siloxanes comprising silyl phosphonate and/or alkyl phosphonate groups. The present invention therefore further provides oligomeric or polymeric siloxanes which comprise silyl phosphonate and/or alkyl phosphonate groups and are prepared by the process of the invention.

To prepare the oligomeric or polymeric siloxanes of the invention comprising phosphonic acid groups, the oligomeric or polymeric siloxanes comprising silyl phosphonate and/or alkyl phosphonate groups which are obtained are converted by ester cleavage into the corresponding oligomeric or polymeric siloxanes comprising phosphonic acid groups. The ester cleavage can be carried out by methods known to those skilled in the art, with oligomeric or polymeric siloxanes comprising silyl phosphonate groups generally being able to be converted into the corresponding oligomeric or polymeric siloxanes comprising phosphonic acid groups under milder conditions than the corresponding oligomeric or polymeric siloxanes comprising alkyl phosphonate groups. A process for cleaving the silyl phosphonate groups has been mentioned above.

The present invention therefore further provides a process for preparing oligomeric or polymeric siloxanes comprising phosphonic acid groups, which comprises the steps
(i) phosphonylation of halogenated oligomeric or polymeric siloxanes comprising one or more units of the formula (II),
   (step (i) has been described above)
(ii) setting-free of the corresponding oligomeric or polymeric siloxanes comprising phosphonic acid groups
(iia) from the silyl esters by alcoholysis
   or
(iib) from the alkyl esters by ester cleavage/pyrolysis/thermolysis at elevated temperature or by acidolysis using concentrated acids.
   Step (iia) Setting-Free of the Corresponding Oligomeric or Polymeric Siloxanes Comprising Phosphonic Acid Groups from the Corresponding Silyl Esters by Alcoholysis

The alcoholysis of the oligomeric or polymeric siloxanes comprising silyl phosphonate groups is carried out by methods known to those skilled in the art. The setting-free of the corresponding oligomeric or polymeric siloxanes comprising phosphonic acid groups from the corresponding silyl esters can be achieved not only by means of an alcohol but also by means of another organic compound which has acidic hydrogen atoms, or by means of water. However, in a preferred embodiment, the setting-free is carried out by means of an alcohol, preferably methanol.

In a preferred embodiment, the setting-free of the corresponding oligomeric or polymeric siloxanes comprising phosphonic acid groups from the corresponding silyl esters by alcoholysis in step (iia) is carried out simultaneously with the purification of the oligomeric or polymeric siloxanes comprising phosphonic acid groups. A preferred embodiment of a process according to step (iia) comprising the setting-free of the oligomeric or polymeric siloxanes comprising phosphonic acid groups from the corresponding silyl esters by alcoholysis and simultaneous purification of the corresponding oligomeric or polymeric siloxanes comprising phosphonic acid groups is described below:

After completion of the phosphonylation (step (i)) of the process of the invention, the reaction mixture comprising oligomeric or polymeric siloxanes comprising silyl phosphonate groups is generally taken up in a suitable low-boiling solvent, for example tetrahydrofuran, and freed of solvent, reaction residues and catalyst by precipitation by means of water or an organic compound having acidic hydrogen atoms, for example an alcohol, preferably methanol, with the silyl ester being cleaved to form the corresponding phosphonic acid at the same time. The amount of alcohol used for this purpose is usually from three to twenty times the weight of the oligomeric or polymeric siloxanes comprising silyl phosphonate groups which are to be reacted. Improved removal of the catalyst can be achieved by acidification of the reaction mixture by means of from 0.1 to 5% by volume of a strong mineral acid, preferably concentrated HCl, HBr or dilute HNO₃. The organic compound having acidic hydrogen atoms, preferably the alcohol, particularly preferably methanol, is generally replaced after a time of from 30 to 120 minutes and the above-described process is preferably repeated from 3 to 10 times. The purification and alcoholysis step can be intensified by simultaneous action of ultrasound or by Soxhlet extraction of the reaction mixture, generally with a weakly acidic alcohol such as methanol in combination with HCl, HBr or HNO₃ for a period of generally from 12 to 48 hours. A further possible way of carrying out simultaneous purification and ester cleavage in step (iia) of the process of the invention is repeated dissolution and precipitation of the reaction product in suitable solvents and acidic precipitants. Examples of suitable solvents are dimethylacetamide (DMAC), N-methyl-2-pyrrolidone (NMP), dimethylformamide (DMF), tetrahydrofuran (THF) and mixtures thereof, and suitable precipitants are, for example, water, methanol, ethanol, isopropanol and mixtures thereof. The purified oligomeric or polymeric siloxane comprising phosphonic acid groups which is obtained is generally freed of the extractant by drying at generally from 50 to 100° C. under reduced pressure.

Step (iib) Setting-Free of the Corresponding Oligomeric or Polymeric Siloxanes Comprising Phosphonic Acid Groups from the Alkyl Esters by Ester Cleavage/Pyrolysis/Thermolysis at Elevated Temperature or by Acidolysis Using Concentrated Acids

The ester cleavage of oligomeric or polymeric siloxanes comprising alkyl phosphonate groups is effected by methods known to those skilled in the art. The oligomeric or polymeric siloxane comprising alkyl phosphonate groups is usually heated at 250-400° C., preferably 270-375° C., very particularly preferably 275-330° C., with exclusion of oxygen under protective gas (e.g. nitrogen). The reaction time in the ester cleavage of the alkyl esters is generally from 10 minutes to 4 hours, preferably from 15 minutes to 3 hours, particularly preferably from 30 minutes to 1 hour.

Subsequent to the ester cleavage, purification of the oligomeric or polymeric siloxanes of the invention comprising phosphonic acid groups is generally carried out. Purification is effected by methods known to those skilled in the art, for example, by dissolution of the oligomeric or polymeric siloxane in a low-boiling solvent such as THF and reprecipitation in water or methanol. Subsequent to the purification, the purified oligomeric or polymeric siloxanes comprising phosphonic acid groups which have been obtained according to the invention are dried at temperatures of generally from 50 to 100° C. under reduced pressure.

An alternative to the ester cleavage at elevated temperature is a setting-free of the oligomeric or polymeric siloxanes of the invention comprising phosphonic acid groups from the corresponding alkyl esters by acidolysis using concentrated acids. Suitable concentrated acids are preferably concentrated hydrogen halides. To carry out the acidolysis, the corresponding oligomeric or polymeric siloxane comprising alkyl phosphonate groups is dissolved in a solvent. A concentrated acid, preferably a concentrated hydrogen halide, is subsequently added. The amount of concentrated acid is 35-48% by weight. The acidolysis is carried out at reflux temperature. The reaction time for the acidolysis is generally from 2 to 48 hours, preferably from 4 to 24 hours. The oligomeric or polymeric siloxanes of the invention comprising phosphonic acid groups which are obtained subsequent to the acidolysis are purified subsequent to the acidolysis. Suitable purification methods are known to those skilled in the art.

The purified oligomeric or polymeric siloxanes of the invention comprising phosphonic acid groups which are obtained are generally then dried at temperatures of generally from 50 to 100° C. under reduced pressure.

In general, more than 60%, preferably more than 70%, particularly preferably more than 80%, very particularly preferably more than 90%, of the corresponding silyl esters or alkyl esters is cleaved in step (ii) of the process of the invention. The reaction product after carrying out step (ii) therefore generally comprises more than 60%, preferably more than 70%, particularly preferably more than 80%, very particularly preferably more than 90%, of oligomeric or polymeric siloxanes comprising phosphonic acid groups and comprising one or more units of the general formula (I).

The present invention thus further provides oligomeric or polymeric siloxanes comprising phosphonic acid groups which have been prepared by the process of the invention.

The oligomeric or polymeric siloxanes of the invention comprising phosphonic acid groups and comprising units of the formula I and/or the siloxanes of the invention comprising silyl phosphonate or alkyl phosphonate groups can be used for producing membranes, films or composites. The oligomeric or polymeric siloxanes of the invention comprising phosphonic acid groups and comprising units of the formula I and/or the siloxanes of the invention comprising silyl phosphonate or alkyl phosphonate groups are preferably used for producing membranes. These proton-conducting membranes can be used as membranes in fuel cells or in separation technology, for example as selectively permeable membranes in the desalination of water, wastewater purification, dialysis or ion extraction or retention, or as separators in electrolytic or electrochemical cells.

The present invention therefore further provides membranes, films and composites comprising at least one siloxane according to the invention comprising phosphonic acid groups and/or at least one siloxane according to the present invention comprising silyl phosphonate or alkyl phosphonate groups.

The oligomeric or polymeric siloxanes of the invention comprising phosphonic acid groups and comprising units of the formula I and/or the siloxanes of the invention comprising silyl phosphonate or alkyl phosphonate groups can also be used together with further compounds, for example in the form of polymer blends. These polymer blends are likewise suitable for producing membranes, films or composites, as indicated above. The oligomeric or polymeric siloxanes of the invention comprising phosphonic acid groups and comprising units of the formula I and/or the siloxanes of the invention comprising silyl phosphonate or alkyl phosphonate groups are particularly useful as additives in membranes in order to increase the proton conductivity, the water retention and to increase the operating temperature, which is of particular interest for membranes of fuel cells.

Suitable partners for the polymer blends are unfunctionalized polymers. For the purposes of the present invention, the term “unfunctionalized polymer” refers to polymers which are neither perfluorinated and sulfonated or carboxylated (ionomeric) polymers such as Nafion® or Flemion® (carboxylic acid polyelectrolyte) nor polymers functionalized with suitable groups to give a sufficient proton conductivity, for example —SO₃H groups or —COOH groups. These unfunctionalized polymers which can be used for the purposes of the present invention are not subject to any particular restrictions as long as they are stable in the applications in which the polymer systems of the invention are used. If, according to a preferred use, they are used in fuel cells, polymers which are thermally stable up to 100° C., preferably up to 200° C. or higher, and have a very high chemical stability are to be used. Preference is given to using:
polymers having an aromatic backbone, for example polyimides, polysulfones, polyether sulfones such as Ultrason®, polyaryl ether ketones such as polyether ether ketones (PEEK), polyether ketones (PEK), polyether ketone ketones (PEKK), polyether ether ketone ketones (PEEKK), polybenzothiazoles, polybenzimidazoles, polyamides, polyphenylene oxides, e.g. poly-2,6-dimethyl-1,4-phenylene oxides, polyphenylene sulfides, polyphenylenes,
polymers having a fluorinated backbone, for example Teflon® or PVDF,
thermoplastic polymers or copolymers such as polycarbonates, for example polyethylene carbonate, polypropylene carbonate, polybutadiene carbonate or polyvinylidene carbonate, or polyurethanes as are described, inter alia, in WO 98/44576,
crosslinked polyvinyl alcohols,
vinyl polymers such as
   polymers and copolymers of styrene or methylstyrene, vinyl chloride, acrylonitrile, methacrylonitrile, N-methylpyrrolidone, N-vinylimidazole, vinyl acetate, vinylidene fluoride,
   copolymers of vinyl chloride and vinylidene chloride, vinyl chloride and acrylonitrile, vinylidene fluoride and hexafluoropropylene,
   terpolymers of vinylidene fluoride and hexafluoropropylene and a compound from the group consisting of vinyl fluoride, tetrafluoroethylene and trifluoroethylene; such polymers are disclosed, for example, in U.S. Pat. No. 5,540,741 whose relevant disclosure is fully incorporated by reference into the present patent application;
phenol-formaldehyde resins, polytrifluorostyrene, poly-2,6-diphenyl-1,4-phenylene oxide, polyaryl ether sulfones, polyarylene ether sulfones, phosphonated poly-2,6-dimethyl-1,4-phenylene oxide;
homopolymers, block polymers and copolymers prepared from:
   olefinic hydrocarbons such as ethylene, propylene, butylene, isobutene, propene, hexene or higher homologues, butadiene, cyclopentene, cyclohexene, norbornene, vinylcyclohexane,
   acrylic or methacrylic esters such as methyl, ethyl, propyl, isopropyl, butyl, isobutyl, hexyl, octyl, decyl, dodecyl, 2-ethylhexyl, cyclohexyl, benzyl, trifluoromethyl or hexafluoropropyl esters or tetrafluoropropyl acrylate or tetrafluoropropyl methacrylate,
   vinyl ethers such as methyl, ethyl, propyl, isopropyl, butyl, isobutyl, hexyl, octyl, decyl, dodecyl, 2-ethylhexyl, cyclohexyl, benzyl, trifluoromethyl or hexafluoropropyl or tetrafluoropropyl vinyl ethers;
basic, nitrogen-comprising polymers such as poly(p-phenylquinoxaline), poly(benzimidazoles).

All these unfunctionalized polymers can in principle be used in crosslinked or uncrosslinked form. It is also possible to use mixtures of the polymers mentioned.

Particularly preferred unfunctionalized polymers suitable as blend partners are polymers having an aromatic backbone, for example polyimides, polysulfones, polyether sulfones such as Ultrason®, polyaryl ether ketones such as polyether ether ketones (PEEK), polyether ketones (PEK), polyether ketone ketones (PEKK), polyether ether ketone ketones (PEEKK), polybenzothiazoles, polybenzimidazoles, polyamides, polyphenylene oxides, e.g. poly-2,6-dimethyl-1,4-phenylenoxides, polyphenylene sulfides, polyphenylenes. Very particular preference is given to polysulfones and polyether sulfones.

The siloxane of the invention comprising phosphonic acid groups and/or the siloxane comprising silyl phosphonate or alkyl phosphonate groups can also be used together with one or more further functionalized polymers. For the present purposes, functionalized polymers are polymers which are ion-conducting, in particular proton-conducting. They can be either basic or acidic polymers. Preferred proton-conducting polymers having acid groups are polymers comprising sulfonic acid groups, phosphonic acid groups and/or carboxylic acid groups. For the present purposes, sulfonic acid, carboxylic acid and/or phosphonic acid groups are groups of the formulae —SO₃X, —COOX and —PO₃X₂, where X is H, NH₄⁺, NH₃R⁺, NH₂R₃⁺, NHR₃⁺ or NR₄⁺, where R is any radical, preferably an alkyl radical, which optionally bears one or more further radicals which can release protons under the conditions usually prevailing in fuel cells. These polymers are known to those skilled in the art and are commercially available or can be prepared by methods known to those skilled in the art. Suitable functionalized polymers are disclosed, for example, in WO 2004/076530, EP-A 0 574 791, EP-A 0 008 895, EP-A 0 575 807, WO 02/077068, WO 03/054991, JP 2000294033 A2, JP 2001233974 A2 and JP 2002025580. Preferred basic polymers are poly(benzimidazole), poly(p-phenylquinoxaline) or mixtures thereof. These polymers are known to those skilled in the art and are commercially available or can be prepared by methods known to those skilled in the art.

Preferred functionalized polymers are, for example, polymers comprising sulfonic acid groups and selected from the group consisting of perfluorinated sulfonated hydrocarbons such as Nafion® from E. I. DuPont, sulfonated aromatic polymers such as sulfonated polyaryl ether ketones such as polyether ether ketones (sPEEK), sulfonated polyether ketones (sPEK), sulfonated polyether ketone ketones (sPEKK), sulfonated polyether ether ketone ketones (sPEEKK), sulfonated polyarylene ether sulfones, sulfonated polybenzobisbenzazoles, sulfonated polybenzothiazoles, sulfonated polybenzimidazoles, sulfonated polyamides, sulfonated polyetherimides, sulfonated polyphenylene oxides, e.g. poly-2,6-dimethyl-1,4-phenylene oxides, sulfonated polyphenylene sulfides, sulfonated phenol-formaldehyde resins (linear or branched), sulfonated polystyrenes (linear or branched), sulfonated polyphenylenes and further sulfonated aromatic polymers.

The sulfonated aromatic polymers can be partially fluorinated or perfluorinated. Further sulfonated polymers comprise polyvinylsulfonic acids, copolymers made up of acrylonitrile and 2-acrylamido-2-methyl-1-propanesulfonic acids, acrylonitrile and vinylsulfonic acids, acrylonitrile and styrenesulfonic acids, acrylonitrile and methacryloxyethyleneoxypropanesulfonic acids, acrylonitrile and methacryloxyethyleneoxytetrafluoroethylenesulfonic acids, etc. The polymers can again be partially fluorinated or perfluorinated. Further groups of suitable sulfonated polymers comprise sulfonated polyphosphazenes such as poly(sulfophenoxy)phosphazenes or poly(sulfoethoxy)phosphazenes. The polyphosphazene polymers can be partially fluorinated or perfluorinated. Sulfonated polyphenylsiloxanes and copolymers thereof, poly(sulfoalkoxy)phosphazenes, poly(sulfotetrafluoroethoxypropoxy)siloxanes are likewise suitable.

Examples of suitable polymers comprising carboxylic acid groups comprise polyacrylic acid, polymethacrylic acid and any copolymers thereof. Suitable polymers are, for example, copolymers with vinylimidazole or acrylonitrile. The polymers can again be partially fluorinated or perfluorinated.

Suitable polymers comprising phosphonic acid groups are, for example, polyvinylphosphonic acid, polybenzimidazolephosphonic acid, phosphonated polyphenylene oxides, e.g. poly-2,6-dimethylphenylene oxides etc. The polymers can be partially fluorinated or perfluorinated.

Furthermore, the oligomeric or polymeric siloxanes of the invention comprising phosphonic acid groups and comprising units of the formula I and/or the siloxanes of the invention comprising silyl phosphonate or alkyl phosphonate groups can be used together with acid/base blends as are disclosed, for example, in WO 99/54389 and WO 00/09588. These are generally polymer blends comprising a polymer comprising sulfonic acid groups and a polymer bearing primary, secondary or tertiary amino groups, as are disclosed in WO 99/54389, or polymer blends obtained by mixing of polymers which comprise basic groups in the side chain with polymers comprising sulfonate, phosphonate or carboxylate groups (acid or salt form). Suitable polymers comprising sulfonate, phosphonate or carboxylate groups have been mentioned above (see polymers comprising sulfonic acid, carboxylic acid or phosphonic acid groups). Polymers comprising basic groups in the side chain are polymers which are obtained by side chain modification of engineering aryl main chain polymers which can be deprotonated by means of organometallic compounds with arylene-comprising N-basic groups, with aromatic ketones and aldehydes comprising tertiary basic N groups (e.g. tertiary amine or basic N-comprising heterocyclic aromatic compounds such as pyridine, pyrimidine, triazine, imidazole, pyrazole, triazole, thiazole, oxazole, etc.) are linked with the metallated polymer. Here, the metal alkoxide formed as intermediate can, in a further step, either be protonated by means of water or etherified by means of haloalkanes (WO 00/09588).

It is likewise possible for the oligomeric or polymeric siloxanes of the invention comprising phosphonic acid groups and comprising units of the formula I and/or the siloxanes of the invention comprising silyl phosphonate or alkyl phosphonate groups to be used together with a plurality of the abovementioned functionalized polymers. Furthermore, the blends can additionally comprise one or more unfunctionalized polymers. Suitable unfunctionalized polymers have likewise been mentioned above.

Particularly preferred functionalized polymers used as blend partners are polymers comprising sulfonic acid groups, with suitable polymers comprising sulfonic acid groups having been mentioned above. Very particular preference is given to blends comprising at least one siloxane of the invention comprising phosphonic acid groups and/or at least one siloxane comprising silyl phosphonate or alkyl phosphonate groups and at least one functionalized, preferably sulfonated, polymer. Very particularly preferred sulfonated polymers are selected from the group consisting of sulfonated poly(ether ether ketone), poly(phenyl sulfone), poly(sulfone) and poly(ether sulfone). Further functionalized polymers which are preferably used as blend partners are the basic polymers poly(benzimidazole), poly(p-phenylquinoxaline) or mixtures thereof and also derivatives thereof. These can form acid/base blends with the oligomeric or polymeric siloxanes of the invention comprising phosphonic acid groups and comprising units of the formula (I) and/or the siloxanes of the invention comprising silyl phosphonate or alkyl phosphonate groups.

The polymer blends generally comprise from 0.1 to 95% by weight, preferably from 1 to 25% by weight, of the oligomeric or polymeric siloxanes of the invention comprising phosphonic acid groups and comprising units of the formula I and/or the siloxanes of the invention comprising silyl phosphonate or alkyl phosphonate groups and generally from 99.9 to 5% by weight, preferably from 75 to 99% by weight, of at least one further polymer.

The present application therefore further provides blends comprising at least one siloxane according to the invention comprising phosphonic acid groups and/or at least one siloxane comprising silyl phosphonate or alkyl phosphonate groups and at least one further polymer, preferably at least one further functionalized polymer.

Preferred oligomeric or polymeric siloxanes comprising phosphonic acid groups and oligomeric or polymeric siloxanes comprising silyl phosphonate or alkyl phosphonate groups and preferred further polymers have been mentioned above.

It has surprisingly been found that when blends of at least one oligomeric or polymeric siloxane comprising phosphonic acid groups or at least one oligomeric or polymeric siloxane comprising silyl phosphonate or alkyl phosphonate groups and at least one further functionalized polymer are used, membranes having excellent ion conductivity and fuel cells having excellent performance which goes beyond the expected summation of the individual performances of the functionalized polymers mentioned are obtained.

Membranes comprising at least one siloxane according to the invention comprising phosphonic acid groups and/or at least one siloxane comprising silyl phosphonate or alkyl phosphonate groups can be produced by methods known to those skilled in the art. Suitable processes are described, for example, in U.S. Pat. No. 6,828,407 B2.

A preferred process for producing membranes comprising at least one siloxane according to the invention comprising phosphonic acid groups and/or at least one siloxane comprising silyl phosphonate or alkyl phosphonate groups is described below.

Phosphonic acid polyelectrolyte membranes comprising the oligomeric or polymeric siloxanes of the invention comprising phosphonic acid groups and comprising units of the formula I and/or the siloxanes of the invention comprising silyl phosphonate or alkyl phosphonate groups or comprising the siloxanes of the invention in the form of additives are generally produced by dissolution or dispersion of the phosphonic-acid siloxane in an organic solvent, application of the preferably filtered solution or mixture to a suitable surface or impregnation of a support material with the same and subsequent partial to complete evaporation of the solvent. The addition of soluble or homogeneously dispersed additives such as further polyelectrolytes, stabilizers, fillers and porogens such as poly(ethylene oxide), poly(propylene oxide), poly(vinyl alcohol) to the preferably filtered polymer solution and subsequent processing to form a membrane is also possible. The choice of solvent is restricted only by a suitable solvent power and inertness in respect of the phosphonic-acid aromatic polymer and comprises chlorinated hydrocarbons such as dichloromethane, chloroform and carbon tetrachloride, 1,2-dichloroethane, chlorobenzene and dichlorobenzene, ethers such as diethyl ether, tetrahydrofuran and dioxane, alkylene glycol alkyl ethers such as ethylene glycol methyl ether, ethylene glycol ethyl ether and propylene glycol methyl ether, alcohols such as methanol, ethanol and propanol and also the preferred, aprotic, polar liquids of the amide type, e.g. N,N-dimethylformamide, N,N-dimethylacetamide and N-methylpyrrolidone, with particular preference being given to N-methylpyrrolidone, and also mixtures of these solvents.

An improvement in the solubility, particularly of highly functionalized phosphonic-acid siloxanes, in organic solvents can be achieved, for example, by addition of 0.05-2% by volume of a strong acid to the solvent, as long as this does not hinder the formation of a homogeneous solution. Acids used are concentrated aqueous hydrogen halide solutions, e.g. HCl or HBr, or concentrated sulfuric acid or nitric acid or strong organic acids such as alkylsulfonic acids and trifluoroacetic acid.

Possible surfaces for application of the polymer solutions are, for example, glass, glasses and plastic films which have been hydrophobicized by silanation, plastic meshes as support materials, porous polymer membranes and other substrates suitable for reinforcement, flexibilization and increasing the toughness.

After application of the polymer solution to the surface as described above or impregnation of the substrate as described above, the solvent is completely or partly removed by evaporation at temperatures of generally 0-150° C. If the solvent is very largely removed by means of a sufficient drying temperature and time, a homogeneous membrane without morphological structuring is generally obtained.

The residual amount of the solvent in the film can be influenced by choice of drying temperature and time. Surface-porous, unsymmetrical membrane morphologies can be produced by dipping a film or composite comprising residual solvent into a precipitation bath which is miscible with the solvent but incompatible with the polyelectrolyte. The characteristics and morphology of the porous structuring produced thereby can be influenced by the residual solvent content, the choice of precipitation bath and its temperature.

The membrane structures produced can be used for increasing the surface area required for taking up ions or contacting the membrane with an electrode layer and also as microscopic hollow spaces for precipitation of the polymeric or low molecular weight substances which have a positive influence on the proton conductivity, e.g. acidic polyelectrolytes or polyvalent metal phosphates, metal phosphonates and polyvalent metal sulfonephosphonates, silicates which promote water retention at elevated temperature or acid-functionalized silicates, as long as the chemical resistance and mechanical strength, flexibility and separating power of the membrane are not adversely affected.

The thickness of the membrane produced can be influenced by the concentration of the polymer electrolyte solutions used, the layer thickness of the polymer solution applied and also the thickness of the support material used, with a very thin membrane being preferred in order to increase the proton conductivity. A preferred membrane thickness for use as fuel cell membrane is 1-200 μm and is selected so that a very high proton conductivity results at an appropriate mechanical strength and diffusion barrier action.

The present invention therefore further provides membranes, films or composites comprising at least one siloxane according to the invention comprising phosphonic acid groups and/or at least one siloxane comprising silyl phosphonate or alkyl phosphonate groups or a blend according to the invention comprising at least one siloxane according to the invention comprising phosphonic acid groups and/or at least one siloxane comprising silyl phosphonate or alkyl phosphonate groups and at least one further polymer.

Preferred oligomeric or polymeric siloxanes comprising phosphonic acid groups and oligomeric or polymeric siloxanes comprising silyl phosphonate or alkyl phosphonate groups and preferred further polymers have been mentioned above.

These membranes can be used in fuel cells and as membranes in separation technology, preferably as selectively permeable membranes in the desalination of water, wastewater purification, dialysis and in ion extraction and retention.

The present invention further provides a fuel cell comprising at least one membrane or at least one siloxane according to the invention comprising phosphonic acid groups and/or at least one siloxane comprising silyl phosphonate or alkyl phosphonate groups or blends according to the present invention.

Furthermore, the present invention provides for the use of the membranes of the invention in fuel cells.

A further application of the phosphonic-acid polyelectrolytes (i.e. the oligomeric or polymeric siloxanes of the invention comprising phosphonic acid groups and comprising units of the formula I and/or the siloxanes of the invention comprising silyl phosphonate or alkyl phosphonate groups or blends with further polymers) is the reduction of swelling of aromatic polyphosphonic acid membranes and polyelectrolyte-polyphosphonic acid blend membranes via ionically crosslinking in-situ formation of polyvalent metal polyphosphonates, e.g. zirconium(IV) polyphosphonates, by action of metal salt solutions of polyvalent metals, e.g. Zr(IV) salt solutions such aqueous zirconyl chloride, on such membranes.

It has surprisingly been found that the treatment of membranes of the phosphonic-acid polyelectrolytes of the invention (i.e. the oligomeric or polymeric siloxanes comprising phosphonic acid groups and comprising units of the formula I and/or the siloxanes of the invention comprising silyl phosphonate or alkyl phosphonate groups or blends with further polymers), in particular of blend membranes (comprising the above-mentioned blends), with aqueous salt solutions of polyvalent metals, e.g. Zr(IV) salt solutions, in particular ZrOCl₂ solutions, brings about a considerable reduction in swelling with simultaneous retention of the conductivity.

The present invention therefore further provides for the use of the oligomeric or polymeric siloxanes of the invention comprising phosphonic acid groups and comprising units of the formula I and/or the siloxanes of the invention comprising silyl phosphonate or alkyl phosphonate groups for reducing swelling of aromatic polyphosphonic acid membranes and polyelectrolyte-polyphosphonic acid blend membranes via ionically crosslinking in-situ formation of polyvalent metal polyphosphonates, e.g. zirconium(IV) polyphosphonates, and aromatic polyphosphonic acid membranes and polyelectrolyte-polyphosphonic acid blend membranes comprising polyvalent metal polyphosphonates, e.g. zirconium(IV) polyphosphonates.

The polyelectrolytes of the invention can likewise serve as nonmigrating polyphosphonic acid component in blend membranes with basic nitrogen-comprising aromatic polymers such as poly(benzimidazole) or poly(p-phenylquinoxaline).

Furthermore, the siloxanes of the invention bearing phosphonic acid groups and/or the siloxanes comprising silyl phosphonate and/or alkyl phosphonate groups can serve to bind metal ions, preferably selected from among metal ions of titanium, zinc, tin, magnesium, germanium, zirconium, aluminum, hafnium, the alkaline earth metals, rhodium, palladium, platinum, gold, silver and the actinides. Here, the siloxanes of the invention are used as heat- and oxidation-resistant cation exchangers for the extraction and/or binding of the abovementioned metal ions.

Furthermore, the siloxanes of the invention can form complexes with metal ions, either via the phosphonic acid group of the siloxanes of the invention or via the siloxane skeleton and can thus be used for supporting catalytically active metal derivatives, for example in organic synthesis. A further field of use of the siloxanes of the invention comprising phosphonic acid groups is their use as acid catalysts in organic synthesis. Here, the preferred arylphosphonic-acid siloxane types according to the present invention are, owing to their aromatic character, superior to the alkylphosphonic-acid siloxane types which can be prepared by the process of the prior art due to an inherently higher heat, free radical and oxidation resistance.

The present invention further provides for the use of the oligomeric or polymeric siloxanes of the invention comprising phosphonic acid groups and/or the oligomeric or polymeric siloxanes of the invention comprising silyl phosphonate and/or alkyl phosphonate groups or the blends of the invention for aiding or improving contact between materials selected from the group consisting of the following classes of substances: metals, plastics and further materials, e.g. apatites, with the aiding or improvement of contact being able to occur between a plurality of materials of a single class of substances and/or between materials of a plurality of the classes of substances mentioned, for example for aiding or improving contact between apatite surfaces of teeth or bones and plastic or metal implants.

The present invention further provides for the use of the oligomeric or polymeric siloxanes of the invention comprising phosphonic acid groups and/or the oligomeric or polymeric siloxanes of the invention comprising silyl phosphonate and/or alkyl phosphonate groups or the blends of the invention in or as corrosion-inhibiting metal coatings or their use as bonding layer between metal surfaces and further materials.

The following examples illustrate the invention:

### EXAMPLE 1

### Preparation of a Phosphonic-Acid Hybrid Electrolyte Based on a Polyhedral Octaphenylsilsesquisiloxane POSS

Preparation of Polyhedral Octaphenylsilsesquisiloxane phT8 (J. F. Brown, L. H. Vogt, P. I. Prescott, JACS, 86, 1120-1125, 1964)

1000 ml of distilled water are placed in a 2 l three-neck flask provided with precision glass stirrer, reflux condenser and connected gas wash bottle. 105.8 g (0.5 mol) of phenyltrichlorosilane (PTCS) in 500 ml of benzene which has been dried over molecular sieves are fed in via a dropping funnel over a period of about 15 minutes while stirring vigorously. After mixing of the phases at room temperature for two hours, the mixture is transferred to a separating funnel and the aqueous phase is separated off. Washing is continued by shaking with 200 ml each time of distilled water and taking off the aqueous phase until the aqueous phase is pH neutral. The benzene phase is transferred to a 1 l single-neck flask and admixed with 16.6 ml of 40% strength methanolic trimethylbenzylammonium hydroxide, resulting in a crystalline white solid immediately precipitating from the clear solution. The amount of precipitate increases visibly on subsequent refluxing in an oil bath having a temperature of 90° C. After 4 hours, the oil bath is removed, the mixture is stored at room temperature without stirring for 96 hours and then refluxed again at 90° C. for 24 hours.

After cooling to room temperature, the mixture is filtered through a G3 porcelain frit and washed with a generous amount of cold methanol. The white crystals obtained have a characteristic silicate crunch and are dried at 100° C. under reduced pressure for 24 hours.

The product obtained will hereinafter be referred to as phT8. It proves to be insoluble in tetrahydrofuran, acetone, dimethyl sulfoxide, methanol, i-propanol, chloroform, 1,1,2,2-tetrachlorethane and acetonitrile. The product is soluble in N-methylpyrrolidone, N,N-dimethylacetamide and N,N-dimethylformamide on warming to about 75° C. and in 1,3,5-trichlorobenzene, benzophenone, diphenyl sulfone and diphenyl ether on warming to 150° C.

| | |
|---|---|
| Yield: | 57.19 g |

(0.443 mol of phenyl-SiO_{1.5} units, corresponding to 88.5% of theory)

### Elemental Analysis:

| | | |
|---|---|---|
| C: | 55.78% (calc.) | 56.85% (found) |
| H: | 3.90% (calc.) | 4.76% (found) |

Preparation of the Brominated Polyhedral Octaphenylsilsesquisiloxane br-phT8-1

20 g of phT8 (154.8 mmol of phenyl units) and 40 ml of 1,1,2,2-tetrachloroethane (TCE) are placed in a 250 ml three-neck flask provided with magnetic stirrer, dropping funnel and reflux condenser with connected gas wash bottle. The mixture is placed in an oil bath heated to 110° C. and 37.14 g (232.3 mmol) of elemental bromine in 40 ml of TCE are added over a period of about 15 minutes while stirring rapidly. Rapid evolution of hydrogen bromide occurs, and this gradually becomes weaker about 30 minutes after the end of the bromine addition. The initially white suspension becomes a homogeneous deep reddish brown solution during the course of the first 30 minutes. After the end of the bromine addition, the mixture is heated at 110° C. for a further 90 minutes.

After cooling to room temperature, residual bromine is destroyed by addition of 250 ml of acetone and the mixture is evacuated to dryness on a rotary evaporator. The pale yellowish, viscous mass obtained is washed three times with 100 ml each time of cyclohexane for 15 minutes in an ultrasonic bath, dried under reduced pressure and dissolved in about 100 ml of tetrahydrofuran. Dropwise addition of about 1 l of water results in precipitation of a pale yellow, viscous paste-like mass which after removal of THF on a rotary evaporator forms hard crumbs. These are filtered off, dried, ground in a mortar and finally washed with 100 ml of cyclohexane.

After drying at 120° C. under reduced pressure, the pale yellowish powder obtained proves to be readily soluble in tetrahydrofuran, chloroform, N-methylpyrrolidone, N,N-dimethylacetamide and N,N-dimethylformamide at room temperature and also in dimethyl sulfoxide at 160° C. br-phT8-1 is insoluble in acetone, methanol and acetonitrile.

An ¹H-NMR spectrum and a ²⁹Si-NMR spectrum are recorded on the product obtained, which will hereinafter be referred to as br-phT8-1.

Elemental Analysis of br-phT8-1:

| | | |
|---|---|---|
| C: | 34.63% (calc.) | 35.02% (found) |
| H: | 1.94% (calc.) | 1.96% (found) |

At a degree of bromination per phenyl unit of ds(Br)=0.125*(7.2995/w(C)−13.0975), this corresponds to monobromination of 96.8% of the phenyl units.

Determination of the Bromine Content of br-phT8-1:

Oxidative digestion of br-phT8-1 with KNO₃/NaO₂ and titration with AgNO₃ solution and backtitration with FeSCN solution gives a bromine content w(Br)=37.86% by weight, giving a degree of bromination per phenyl unit ds(Br)=129.19*(w(Br)/100)/(79.91−78.91*(w(Br)/100) of 97.8 mol %, corresponding to monobromination of 97.8% of the phenyl units.

¹H-NMR Spectrum of br-phT8-1 (300 MHz, d₁-Chloroform):
7.14-7.27 ppm, integrated value 1.00 (aryl-H)
7.27-7.42 ppm, integrated value 0.34 (aryl-H)
7.42-7.54 ppm, integrated value 0.78 (aryl-H)
7.60-7.68 ppm, integrated value 0.27 (aryl-H)
7.68-7.83 ppm, integrated value 0.61 (aryl-H)
7.90-7.96 ppm, integrated value 0.06 (aryl-H)
7.97-8.03 ppm, integrated value 0.04 (aryl-H)
²⁹Si-NMR Spectrum of br-phT8-1 (60 MHz, 300 MHz ¹H Broad Band Decoupling, d₁-Chloroform):
−81.9 ppm

The position of the signal and the absence of further signals in the entire chemical shift range examined (−100 ppm-+50 ppm) indicates degradation-free monobromination of the aromatic substituent in the para position relative to the silsesquisiloxane skeleton.

### Preparation of the Phosphonic-Acid Polyhedral Octaphenylsilsesquisiloxane Pho-phT8-1

5 g of br-phT8-1 (24.02 mmol of bromine) together with 623.1 mg (4.81 mmol, corresponding to 0.2 molar equivalent based on the bromine content) of anhydrous Ni(II) chloride are placed in a 50 ml three-neck flask provided with magnetic stirrer, air condenser with connected cold trap and dropping funnel closed with a septum and provided with a nitrogen inlet. On an oil bath heated to 190° C., the mixture is freed of residual moisture by passing a slow stream of nitrogen into it. 5 ml of diphenyl ether are added to the dry mixture under a countercurrent of nitrogen and the mixture is processed with stirring over a period of 30 minutes to give a light-beige solution having a low viscosity. 4.99 g (30.03 mmol) of triethyl phosphite are introduced into the dropping funnel via the septum and these are added to the mixture over a period of 30 minutes while stirring. About 15 seconds after the start of the addition, a color change via dark red to purple is observed and a volatile compound is carried out with the nitrogen stream from the now effervescent mixture (identified as bromoethane by NMR spectroscopy). During the course of the reaction, about 3.5 ml of this liquid are condensed in the cold trap. After about 3 minutes, vigorous foaming, a change in color to dark yellow and an increase in the viscosity are observed. The mixture is heated at 180° C. for the remainder of the reaction time of 8 hours, after which a black, gelled mass is found.

This is largely freed of solvent and volatile reaction residues by passing a vigorous stream of nitrogen over it at 200° C., dissolved in a little tetrahydrofuran (THF) and introduced while stirring into distilled water having a temperature of 80° C. After the THF has evaporated, a few milliliters of 30% perhydrol are added, and rapid decolorization of the black flocks to white and formation of a greenish aqueous phase are observed. The solid constituents are filtered off with suction, freed of organic reaction residues by means of cyclohexane and rinsed with a large amount of water.

Drying gives a compact, pale beige powder which proves to be readily soluble in warm N-methylpyrrolidone and forms an insoluble precipitate of zirconium(IV)polyphosphonic acid on addition of a few drops of 1% strength (m/m) zirconium(IV) acetylacetonate/N-methylpyrrolidone solution.

An ¹H spectrum is recorded on the product obtained, which will hereinafter be referred to as pho-phT8-1.

| | |
|---|---|
| Yield of pho-phT8-1: | 5.4 g |

Determination of the bromine content: Oxidative digestion of pho-phT8-1 with KNO₃/NaO₂ and titration with AgNO₃ solution and backtitration with FeSCN solution gives a bromine content of 5.4% by weight.

¹H-NMR Spectrum of pho-phT8-1 (300 MHz, d₆-Dimethyl Sulfoxide):
0.15-1.63 ppm, integrated value 1.00 (ester-CH₃)
1.05-1.08 ppm, integrated value 0.67 (ester-CH₂)
6.81-8.70 ppm, integrated value 1.2 (aryl-H)

The ratio of the integrals A of ethyl-CH₃ to aryl-H gives, according to the degree of phosphonylation ds(P)=5X/(6+X) and X=A(CH₃)/A(aryl-H), a ds(P) of 61 mol %, corresponding to 0.61 diethyl phosphonate groups per phenyl unit, i.e. 4.9 diethyl phosphonate groups per octaphenylsilsesquisiloxane cage.

Thermogravimetric Analysis of pho-phT8-1 (Netzsch STA 409, Heating Rate 10 K/min, Air Atmosphere):
5% weight loss at 296° C.
25% weight loss at 467° C.
61.5% weight loss at 600° C.

The step-like loss in mass in the range 285-373° C. of 16.1% by weight due to phosphonic ester pyrolysis with elimination of ethene corresponds, at a degree of phosphonylation ds(P)=129.19/((56.106/(loss in mass/100)−136.1), to a ds(P) of 60.8 mol %, corresponding to 0.61 diethyl phosphonate groups per phenyl unit, i.e. 4.9 diethyl phosphonate groups per octaphenylsilsesquisiloxane cage.

Determination of phosphorus content: Oxidative digestion of pho-phT8-1 with KNO₃/NaO₂ and titration with AgNO₃ solution and backtitration with FeSCN solution gives a phosphorus content of 9.2% by weight and a degree of phosphonylation ds(P)=129.19*(w(P)/100)/(31−w(P)/100*136.1))*100 corresponding to 0.64 diethyl phosphonate groups per phenyl unit, i.e. 5.1 diethyl phosphonate groups per octaphenylsilsesquisiloxane cage.

### EXAMPLE 1.1

### Preparation of a Phosphonic-Acid Hybrid Electrolyte Based on a Polyhedral Octaphenylsilsesquisiloxane POSS

Preparation of the Phosphonic-Acid Polymers pho-phT8-1.1

1.5 g of br-phT8-1 (7.22 mmol of bromine) are reacted with 93.6 mg (0.72 mmol; corresponding to 0.1 molar equivalent based on the bromine content) of anhydrous Ni(II) chloride as described under pho-phT8-1 and with 2.59 g (8.66 mmol) of tris(trimethylsilyl) phosphite. During the course of the reaction, the mixture becomes sky blue and about 3 ml of a liquid which fumes in air (identified spectroscopically as trimethylbromosilane) are driven into the cold trap by the stream of nitrogen. After about 2 hours, a distinct increase in viscosity is observed. The mixture is heated at 180° C. for the remainder of the reaction time of 8 hours. The sky blue, gelled mass is worked up as described under pho-phT8-1, with the silyl ester group simultaneously being cleaved off by the final precipitation in water.

Drying gives a compact, pale beige powder which proves to be readily soluble in warm N-methylpyrrolidone with addition of a few drops of concentrated hydrogen bromide solution and on addition of a few drops of 1% strength (m/m) zirconium(IV) acetylacetonate/N-methylpyrrolidone solution gives an insoluble precipitate of zirconium(IV) polyphosphonic acid.

The bromine content is determined titrimetrically and the phosphorus content is determined gravimetrically on the product obtained, which will hereinafter be referred to as pho-phT8-1.1.

| | |
|---|---|
| Yield of pho-phT8-1.1: | 1.4 g |

Determination of the bromine content of pho-phT8-1.1: Oxidative digestion of pho-phT8-1.1 with KNO₃/NaO₂ and titration with AgNO₃ solution and backtitration with FeSCN solution gives a bromine content of 3.4% by weight.

Determination of the phosphorus content of pho-phT8-1.1: Oxidative digestion of pho-phT8-1.1 with KNO₃/NaO₂ and titration with AgNO₃ solution and backtitration with FeSCN solution gives a phosphorus content of 8.24% by weight and a degree of phosphonylation ds(P)=129.19*(w(P)/100)/(31−w(P)/100*81))*100 corresponding to 0.44 phosphonic acid group per phenyl unit, i.e. 3.5 phosphonic acid groups per octaphenylsilsesquisiloxane cage.

### EXAMPLE 1.2

### Preparation of a Phosphonic-Acid Hybrid Electrolyte Based on a Polyhedral Octaphenylsilsesquisiloxane POSS

Preparation of the Phosphonic-Acid Polymer pho-phT8-1.2

2.0 g of br-phT8-1 (9.61 mmol of bromine) are reacted with 125 mg (0.96 mmol, corresponding to 0.1 molar equivalent based on the bromine content) of anhydrous Ni(II) chloride as described under pho-phT8-1 as a solution in 2.0 ml of diphenyl ether and with 2.89 g (11.54 mmol) of tributyl phosphite. During the course of the reaction, the mixture becomes distinctly more viscous after 2 hours. The midnight black, gelled mass obtained after a reaction time of 8 hours is worked up as described under pho-phT8-1.

Drying gives a compact, pale beige powder which proves to be readily soluble in warm N-methylpyrrolidone with addition of a few drops of concentrated hydrogen bromide solution and on addition of a few drops of 1% strength (m/m) zirconium(IV) acetylacetonate/N-methylpyrrolidone solution gives an insoluble precipitate of zirconium(IV) polyphosphonic acid.

The bromine content is determined titrimetrically and the phosphorus content is determined gravimetrically on the product obtained, which will hereinafter be referred to as pho-phT8-1.2.

| | |
|---|---|
| Yield of pho-phT8-1.2: | 1.7 g |

Determination of the bromine content of pho-phT8-1.2: Oxidative digestion of pho-phT8-1.2 with KNO₃/NaO₂ and titration with AgNO₃ solution and backtitration with FeSCN solution gives a bromine content of 3.8% by weight.

Determination of the phosphorus content of pho-phT8-1.2: Oxidative digestion of pho-phT8-1.2 with KNO₃/NaO₂ and titration with AgNO₃ solution and backtitration with FeSCN solution gives a phosphorus content of 7.67% by weight and a degree of phosphonylation ds(P)=129.19*(w(P)/100)/(31−w(P)/100*193.2))*100 corresponding to 0.61 dibutyl phosphonate group per phenyl unit, i.e. 4.9 dibutyl phosphonate groups per octaphenylsilsesquisiloxane cage.

### EXAMPLE 2

### Preparation of a Phosphonic-Acid Hybrid Electrolyte Based on a Polyhedral Octaphenylsilsesquisiloxane POSS

Preparation of the Brominated Precursor br-P2
Preparation of the Brominated Octaphenylsilsesquisiloxane br-phT8-2

20 g of phT8 (154.8 mmol of phenyl units), 40 ml of 1,1,2,2-tetrachloroethane (TCE) and 62 g (387.7 mmol) of elemental bromine are reacted as described under br-phT8-1 but at 140° C. for 2 hours.

Drying at 75° C. under reduced pressure gives a pale yellowish powder. This proves to be readily soluble in tetrahydrofuran, chloroform, N-methylpyrrolidone, N,N-dimethylacetamide and N,N-dimethylformamide at room temperature and also in dimethyl sulfoxide at 160° C. br-phT8-1 is insoluble in acetone, methanol and acetonitrile.

An ¹H-NMR spectrum and a MALDI-TOF spectrum are recorded on the product obtained, which will hereinafter be referred to as br-phT8-2.

### Elemental Analysis:

| | | |
|---|---|---|
| C: | 34.63% (calc.) | 30.79% (found) |
| H: | 1.94% (calc.) | 1.36% (found) |

At a degree of bromination per phenyl unit ds(Br)=0.125*(7.2995/w(C)−13.0975), this corresponds to monobromination of 133% of the phenyl units.

¹H-NMR Spectrum of br-phT8-2 (300 MHz, d₆-Dimethyl Sulfoxide):
7.3-7.55 ppm, integrated value 1.00 (aryl-H)
7.56-7.84 ppm, integrated value 1.23 (aryl-H)
7.85-7.97 ppm, integrated value 0.19 (aryl-H)
8.07-8.12 ppm, integrated value 0.04 (aryl-H)
MALDI-TOF Spectrum of br-phT8-2

The MALDI-TOF sample was prepared by dissolving br-phT8-2, alphacyanohydroxycinnamic acid and lithium chloride in tetrahydrofuran.

1669.71 m/z; relative intensity 1500
1749.58 m/z; relative intensity 3750
1827.58 m/z; relative intensity 5250
1907.34 m/z; relative intensity 3000
1987.27 m/z; relative intensity 1000

The spacings of the signals of a constant 79.9 m/e (molar mass of the bromine atom) and the absence of broadly scattered signals at relatively low m/e values indicate degradation-free bromination of the octaphenylsilsesquisiloxane cage. At a molar mass of the cage of 1033.5 g/mol, a distribution of the achieved degree of bromination of br-phT8-2 in the range from 1.00 to 1.50 can be calculated.

Preparation of the Phosphonic-Acid Polyhedral Octaphenylsilsesquisiloxane pho-phT8-2

9 g of br-phT8-2 (50.5 mmol of bromine) are reacted with 655 mg (5.05 mmol, corresponding to 0.1 molar equivalent based on the bromine content) of anhydrous Ni(II) chloride as described under pho-phT8-1 as a solution in 1.5 g of benzophenone and with 18.84 g (63.1 mmol) of tris(trimethylsilyl) phosphite in a 50 ml three-neck flask. During the course of the reaction, the mixture becomes sky blue while about 3 ml of a liquid which fumes in air (identified spectroscopically as trimethylbromosilane) are driven into the cold trap by the stream of nitrogen. A distinct increase in the viscosity is observed after about 2 hours. The mixture is heated at 180° C. for the remainder of the reaction time of 8 hours. The sky blue, solid mass is worked up as described under pho-phT8-1, with the silyl ester group being cleaved off simultaneously by the final precipitation in water.

Drying gives a compact, pale beige powder which proves to be readily soluble in warm N-methylpyrrolidone with addition of a few drops of concentrated hydrogen bromide solution and on addition of a few drops of 1% strength (m/m) zirconium(IV) acetylacetonate/N-methylpyrrolidone solution gives an insoluble precipitate of zirconium(IV) polyphosphonic acid.

| | |
|---|---|
| Yield of pho-phT8-2: | 8.26 g |

Determination of the bromine content of pho-phT8-2: Oxidative digestion of pho-phT8-2 with KNO₃/NaO₂ and titration with AgNO₃ solution and backtitration with FeSCN solution gives a bromine content of 2.8% by weight.

Determination of the phosphorus content of pho-phT8-2: Oxidative digestion of pho-phT8-2 with KNO₃/NaO₂ and titration with AgNO₃ solution and backtitration with FeSCN solution gives a phosphorus content of 10.92% by weight and a degree of phosphonylation ds(P)=129.19*(w(P)/100)/(31−w(P)/100*81))*100 corresponding to 0.64 phosphonic acid group per phenyl unit, i.e. 5.1 phosphonic acid groups per octaphenylsilsesquisiloxane cage.

1: An oligomeric or polymeric siloxane comprising phosphonic acid groups and comprising one or more units of the general formula (I) 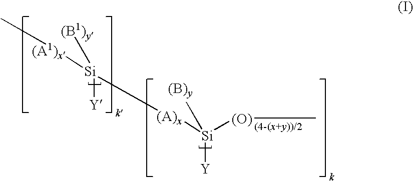
where
Y and Y′ are each, independently of one another, 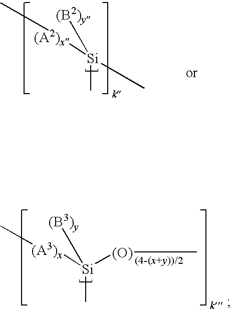
A, A¹, A², A³ are each, independently of one another, 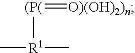
B, B¹, B², B³ are each, independently of one another, 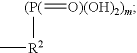
x, y,
x′, y′,
x″, y″,
x′″, y′″ are each, independently of one another, 0, 1 or 2, with the proviso that the sums (x+y), (x′+y′), x″+y″) and (x′″+y′″) are each not more than 3;
m, n are each, independently of one another, 0, 1 or 2; but are not simultaneously 0;
k is an integer ≧2,
k′, k″, k′″ are each from 0 to 4;
R¹ is a divalent or polyvalent aromatic radical which apart from optionally one or more radicals (P(═O)(OH)₂) may bear one or more further substituents and/or comprise one or more heteroatoms;
R² is an aryl or alkyl group which apart from optionally one or more radicals (P(═O)(OH)₂) may bear one or more further substituents and/or bear one or more heteroatoms;
where Y and Y′ can be bound via an Si atom, the group A³ or an O atom and via an Si atom or the group A², respectively, to an Si atom of the compounds of the general formula I.

2. The siloxane according to claim 1, wherein the siloxane is a silsesquisiloxane comprising phosphonic acid groups.

3. The siloxane according to claim 2, wherein the silsesquisiloxane comprising phosphonic acid groups is a partly or completely closed cage-like polyhedral silsesquisiloxane in which k is 6, 8, 10 or 12.

4. The siloxane according to claim 2, wherein the silsesquisiloxane comprising phosphonic acid groups is a ladder-like or unstructured silsesquisiloxane in which x=1, y=0.

5. The siloxane according to claim 4, wherein R¹ is phenylene in the ladder-like or unstructured silsesquisiloxane.

6. A process for preparing oligomeric or polymeric siloxanes comprising phosphonic acid groups according to claim 1, comprising:
(i) phosphonylation of the corresponding halogenated oligomeric or polymeric siloxanes comprising one or more units of the formula (II) 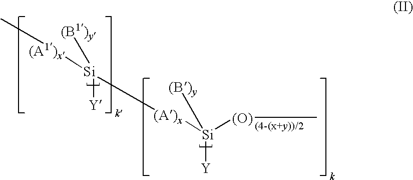
where
Y and Y′ are each, independently of one another, 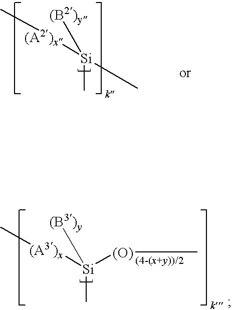
A′, A^{1′}, A^{2′}, A^{3′} are each, independently of one another, 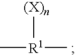
B′, B^{1′}, B^{2′}, B^{3′} are each, independently of one another, 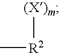
x, y,
x′, y′,
x″, y″,
x′″, y′″ are each, independently of one another, 0, 1 or 2, with the proviso that the sums (x+y), (x′+y′), (x″+y″) and (x′″+y′″) are each not more than 3;
m, n are each, independently of one another, 0, 1 or 2; but are not simultaneously 0;
k is an integer ≧2, where x and y are not simultaneously 0 in at least one of the units of the formula (II);
k′, k″, k′″ are each from 0 to 4;
R¹ is a divalent or polyvalent aromatic radical which may optionally bear one or more further substituents and/or comprise one or more heteroatoms;
R² is an aryl or alkyl group which may optionally bear one or more further substituents and/or comprise one or more heteroatoms;
X, X′ are each halogen;
where Y and Y′ can be bound via an Si atom, the group A³ or an O atom and via an Si atom or the group A 2, respectively, to an Si atom of the compounds of the general formula I;
by means of
silyl and/or alkyl phosphites in the presence of a catalyst, with the phosphonylation being carried out in a nitrogen-free solvent at temperatures of ≧150° C.

7. The process according to claim 6, wherein the silyl phosphites have the general formula (III) or (IV)
P(OSiR³R⁴R⁵)(OSiR⁶R⁷R⁸)(OSiR⁹R¹⁰R¹¹) (III)
or
P(OSiR³R⁴R⁵)(OSiR⁶R⁷R⁸)(OH) (IV)
where
R³, R⁴, R⁵, R⁶, R⁷, R⁸, R⁹, R¹⁰, R¹¹
are each, independently of one another, alkyl, alkenyl, cycloalkyl, aralkyl, aryl, with the abovementioned groups being able to be substituted and/or being able to comprise heteroatoms,
or
are mixtures of O-silylated phosphorous esters which are obtainable by silylation of phosphorous acid by means of one or more aminosilanes, halosilanes and/or alkoxysilanes.

8. The process according to claim 6, wherein the alkyl phosphites have the general formula (V) or (VI),
P(OR¹²)(OR¹³)(OR¹⁴) (V)
or
P(OR¹²)(OR¹³)(OH) (VI)
where
R¹², R¹³, R¹⁴
are each, independently of one another, alkyl, alkenyl, cycloalkyl, aralkyl, with the abovementioned groups being able to be substituted and/or being able to comprise heteroatoms.

9. The process according to claim 6, wherein the catalyst comprises at least one metal selected from the group consisting of Ni, Pd, Pt, Rh, Ru, Os and Ir.

10. The process according to claim 6, wherein the catalyst is used in an amount of from 0.01 to 1 molar equivalent, based on the number of molar equivalents of the halogen in the halogenated oligomeric or polymeric siloxanes comprising one or more units of the formula II.

11. The process according to claim 6, wherein the nitrogen-free solvent is selected from the group consisting of diphenyl ether, benzophenone, diphenyl sulfone, sulfolane, the alkyl- or alkoxy-substituted derivatives of these compounds, aliphatic, partly aromatic, aromatic oligoethers and polyethers, aliphatic, partly aromatic, aromatic β-diketones, the alkyl-, aryl-, alkoxy- or aryloxy-substituted derivatives of these compounds, aliphatic, partly aromatic, aromatic ketone ethers, aliphatic, partly aromatic, aromatic carboxylic acids, aliphatic, partly aromatic, aromatic carbonates and mixtures of the abovementioned compounds.

12. A process for preparing oligomeric or polymeric siloxanes comprising phosphonic acid groups according to claim 1, comprising:
(i) phosphonylation of halogenated oligomeric or polymeric siloxanes comprising one or more units of the formula II 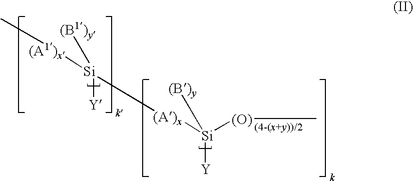
where
Y and Y′ are each, independently of one another, 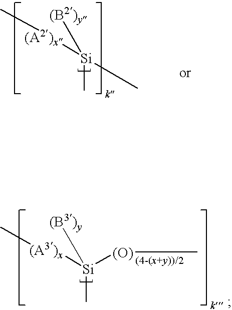
A′, A^{1′}, A^{2′}, A^{3′} are each, independently of one another, 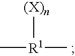
B′, B^{1′}, B^{2′}, B^{3′} are each, independently of one another, 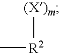
x, y,
x′, y′,
x″, y″,
x′″, y′″ are each, independently of one another, 0, 1 or 2, with the proviso that the sums (x+y), (x′+y′), (x″+y″) and (x′″+y′″) are each not more than 3;
m, n are each, independently of one another, 0, 1 or 2; but are not simultaneously 0;
k is an integer ≧2, where x and y are not simultaneously 0 in at least one of the units of the formula (II);
k′, k″, k′″ are each from 0 to 4;
R¹ is a divalent or polyvalent aromatic radical which may optionally bear one or more further substituents and/or comprise one or more heteroatoms;
R² is an aryl or alkyl group which may optionally bear one or more further substituents and/or comprise one or more heteroatoms;
X, X′ are each halogen;
where Y and Y′ can be bound via an Si atom, the group A³ or an O atom and via an Si atom or the group A2, respectively, to an Si atom of the compounds of the general formula I, giving the corresponding silyl esters and/or alkyl esters;
(ii) setting-free of the corresponding oligomeric or polymeric siloxanes comprising phosphonic acid groups
(iia) from the silyl esters by alcoholysis
or
(iib) from the alkyl esters by ester cleavage/pyrolysis/thermolysis at elevated temperature or by acidolysis using concentrated acids.

13. An oligomeric or polymeric siloxane comprising silyl phosphonate and/or alkyl phosphonate groups and prepared by a process according to claim 6.

14. An oligomeric or polymeric siloxane comprising phosphonic acid groups and prepared by a process according to claim 6.

15. A blend comprising at least one oligomeric or polymeric siloxane comprising phosphonic acid groups according to claim 1 and at least one further polymer.

16. A membrane, film or composite comprising at least one oligomeric or polymeric siloxane comprising at least one phosphonic acid group according to claim 1.

17-18. (canceled)

19. A fuel cell, a membrane in separation technology, or a separator in electrolytic or electrochemical technology, comprising at least one oligomeric or polymeric siloxane comprising phosphonic acid groups according to claim 1.

20. (canceled)

21. A membrane comprising polyvalent metal polyphosphonates produced from oligomeric or polymeric siloxanes comprising phosphonic acid groups according to claim 1 and salts of polyvalent metals or their solutions in suitable solvents.

22-25. (canceled)
